(19) United States
(12) Patent Application Publication
(10) Pub. No.: US 2025/0086524 A1
(43) Pub. Date: Mar. 13, 2025

(54) USER INTERFACES FOR COMPUTER-BASED INVENTORY MANAGEMENT

(71) Applicant: RM Merger Sub II LLC, New York, NY (US)

(72) Inventors: Greg Hong, New York, NY (US); Joe Marchese, New York, NY (US)

(21) Appl. No.: 18/775,556

(22) Filed: Jul. 17, 2024

Related U.S. Application Data
(63) Continuation of application No. 17/144,011, filed on Jan. 7, 2021, now abandoned.
Application No. 17/144,011 is a continuation of application No. 14/922,102, filed on Oct. 23, 2015, now abandoned.
(60) Provisional application No. 62/208,488, filed on Aug. 21, 2015.
(60) Provisional application No. 62/115,819, filed on Feb. 13, 2015.
(60) Provisional application No. 62/069,825, filed on Oct. 28, 2014.
(60) Provisional application No. 62/067,975, filed on Oct. 23, 2014.

(51) Int. Cl. G06Q 10/02; G06F 3/0482; G06Q 10/0875

(52) U.S. Cl. CPC G06Q 10/02; G06F 3/0482; G06Q 10/0875

(57) ABSTRACT

Disclosed are various embodiments for user interfaces for computer-based inventory management. In one embodiment, a first request for an electronic reservation for a contested inventory resource is received from a mobile device through a wireless channel. A suggested additional percentage over an established value of one or more items to be provided in fulfillment of the electronic reservation is determined, where the suggested additional percentage is determined based on data indicating a demand level associated with the contested inventory resource. Data encoding a first user interface that recommends the suggested additional percentage in order to create the electronic reservation and includes one or more graphical components to modify the suggested additional percentage is transmitted via the wireless channel. A second request to create the electronic reservation at a specified additional percentage over the established value is received from the mobile device through the wireless channel.

### CROSS-REFERENCE TO RELATED APPLICATIONS

This application is continuation of co-pending U.S. patent application Ser. No. 17/144,011, entitled “USER INTERFACES FOR COMPUTER-BASED INVENTORY MANAGEMENT” and filed on Jan. 7, 2021, which is a continuation of co-pending U.S. patent application Ser. No. 14/922,102, entitled “USER INTERFACES FOR COMPUTER-BASED INVENTORY MANAGEMENT” and filed on Oct. 23, 2015, which claims priority to and the benefit of the following provisional patent applications:
U.S. Provisional Patent Application No. 62/208,488, entitled “INVENTORY MANAGEMENT SYSTEM AND METHOD” and filed on Aug. 21, 2015;
U.S. Provisional Patent Application No. 62/115,816, entitled “INVENTORY MANAGEMENT SYSTEM AND METHOD” and filed on Feb. 13, 2015;
U.S. Provisional Patent Application No. 62/069,825, entitled “INVENTORY MANAGEMENT SYSTEM AND METHOD” and filed on Oct. 28, 2014; and
U.S. Provisional Patent Application No. 62/067,975, entitled “SYSTEM AND METHOD FOR PROVIDING NETWORK BASED CONCIERGE SERVICES VIA A PORTABLE COMMUNICATION DEVICE FIELD” and filed on Oct. 23, 2014.
   Each of these previously filed applications is incorporated by reference as if set forth herein in their entireties.

### BACKGROUND

Supply-side inventory systems currently are the predominate arrangements for booking restaurant reservations online. If accepting online reservations, a restaurant can post or list online their inventory of available tables suitable for various party sizes at various seating times. Thereby, a potential diner, when online, can view the available table inventory. Assuming a suitable table is listed online, the potential diner reserves the listed table, albeit without providing the restaurant with any context for the reservation or insights about the diner other than perhaps a name and phone number.

Use of the supply-side inventory system in the online embodiments, however, presents several drawbacks. As an initial matter, the online reservations do not enable the restaurant to engage in a conversation with the diner, preventing the restaurant from offering the diner alternative reservation options, such as other seating types or times. Additionally, if a diner who has never before visited a restaurant reserves a table online, the restaurant is left in the dark as to certain characteristics about the diner—e.g., how long the diner usually occupies a table—and is unable to efficiently manage its table inventory and keep control over its dining room. As a result, many restaurants choose to list only a limited amount of their inventory online, usually those tables with the least desirable seating times. For a restaurant's most valuable inventory—i.e., reservations at peak seating times—the restaurant will often still require diners to make a telephone call to book that reservation, allowing the restaurant to better manage inventory and control the dining room, including by ensuring that reservations are available for regular customers.

Furthermore, a restaurant may lose out on potential diners who may not realize that the restaurant is not listing all available inventory online and that calling the restaurant could result in securing the desired reservation. If the potential diner is savvy enough to know that a restaurant is not listing all of its available inventory online, the experience of securing a reservation is still less than optimal because the diner has now had to engage in both an online search and a telephone call inquiry to determine the availability of a desired reservation. If a reservation is not available, the diner must begin his or her search for a satisfactory reservation anew, potentially repeating the online-search-followed-by-telephone-call process several times before securing a satisfactory reservation.

Alternatively, the potential diner can request a reservation by placing a telephone call to the restaurant. The reservation request essentially involves asking for a table for a specific party size at a specific seating time. In considering the reservation request, the restaurant examines a current inventory of tables to determine whether a suitable table will be available at the requested seating time. The telephone call concludes with the restaurant either accepting or declining the reservation request depending upon table availability.

By only considering the inventory of available tables at the time of the telephone call, however, the restaurant fails to account for any subsequent reservation cancellations, which can increase the number of available tables in inventory. In other words, although none may be available during the telephone call, a suitable table subsequently may become available due to a reservation cancellation by another diner. The restaurant thereby has lost not only an opportunity to fill the table, but also an opportunity to gain a loyal regular patron. Furthermore, the potential diner has lost a chance to experience the restaurant.

Currently-used reservation systems thus can be detrimental to both the restaurant and the potential diner.

In view of the foregoing, a need exists for an improved inventory management system and method for matching guest requests with provider inventory in a manner that overcomes the aforementioned obstacles and deficiencies of currently-used reservation systems.

### BRIEF DESCRIPTION OF THE DRAWINGS

FIG. 1 is an exemplary top-level block diagram illustrating an embodiment of an inventory management system suitable for matching user requests with provider inventory.

FIG. 2 is an exemplary top-level flow chart illustrating an embodiment of a method for matching user requests with provider inventory.

FIG. 3 is an exemplary top-level flow chart illustrating an alternative embodiment of the method of FIG. 2, wherein a user is enabled to submit a request.

FIG. 4 is an exemplary top-level flow chart illustrating an alternative embodiment of the method of FIG. 3, wherein the request is evaluated in view of a user profile of the user and a selected provider is recommended for fulfilling the request.

FIG. 5 is an exemplary top-level flow chart illustrating another alternative embodiment of the method of FIG. 2, wherein the provider is enabled to evaluate the request.

FIG. 6 is an exemplary top-level flow chart illustrating an alternative embodiment of the method of FIG. 5, wherein the provider evaluates the request in view of the user profile of the user.

FIG. 7 is an exemplary top-level flow chart illustrating another alternative embodiment of the method of FIG. 2, wherein at least one of the user and the provider are prequalified.

FIG. 8 is an exemplary top-level flow chart illustrating yet another alternative embodiment of the method of FIG. 2, wherein the provider is enabled to fulfill the request.

FIG. 9 is an exemplary top-level flow chart illustrating an embodiment of the method of FIG. 8, wherein the provider is enabled to provide the requested product and/or service and to receive payment.

FIG. 10 is an exemplary top-level flow chart illustrating an embodiment of the method of FIG. 9, wherein an invoice is tendered to the user and payment of the invoice is provided to the provider.

FIG. 11 is an exemplary top-level flow chart illustrating an alternative embodiment of the method of FIG. 9, wherein the user and the provider are enabled to provide a review of each other.

FIG. 12 is an exemplary top-level block diagram illustrating an alternative embodiment of the inventory management system of FIG. 1, wherein the inventory management system is applied in a restaurant environment.

FIG. 13A is an exemplary screenshot illustrating an embodiment a diner interface of the inventory management system of FIG. 12, wherein the diner interface enables the diner to enter selected request terms of a reservation request.

FIG. 13B is an exemplary screenshot illustrating the diner interface of FIG. 13A, wherein the diner interface enables the diner to select a restaurant to receive the reservation request.

FIGS. 13C-E are exemplary screenshots illustrating the diner interface of FIG. 13A, wherein the diner interface enables the diner to view a profile and policies of the selected restaurant.

FIG. 13F is an exemplary screenshot illustrating the diner interface of FIG. 13A, wherein the diner interface enables the diner to view a menu of the selected restaurant.

FIGS. 13G-H are exemplary screenshots illustrating the diner interface of FIG. 13A, wherein the diner interface enables the diner to place a bid when demand for the reservation request is high.

FIG. 13I is an exemplary screenshot illustrating the diner interface of FIG. 13A, wherein the diner interface enables the diner to review the reservation request and to send the reservation request to the selected restaurant.

FIG. 13J is an exemplary screenshot illustrating the diner interface of FIG. 13A, wherein the diner interface provide the diner with a confirmation that the reservation request has been submitted to the selected restaurant and enables the diner to cancel or to add an alternative restaurant.

FIG. 13K is an exemplary screenshot illustrating an alternative embodiment of the diner interface of FIG. 13J, wherein the submission confirmation includes a confirmation sent to the diner via a text message.

FIG. 13L is an exemplary screenshot illustrating the diner interface of FIG. 13A, wherein the diner interface provides the diner with a list of restaurants that can be added to the reservation request.

FIG. 13M is an exemplary screenshot illustrating the diner interface of FIG. 13A, wherein the diner interface presents each pending reservation of the diner.

FIG. 14A is an exemplary screenshot illustrating an embodiment a restaurant interface of the inventory management system of FIG. 12, wherein the restaurant interface enables the restaurant to view each pending reservation request that has been received at the restaurant and to select one of the pending reservation requests.

FIG. 14B is an exemplary screenshot illustrating the restaurant interface of FIG. 14A, wherein the restaurant interface enables the restaurant to select a time slot for the selected reservation request.

FIG. 14C is an exemplary screenshot illustrating the restaurant interface of FIG. 14A, wherein the restaurant interface enables the restaurant to review the terms of the selected reservation request and to confirm the reservation request to the diner.

FIG. 15A is an exemplary screenshot illustrating an alternative embodiment of the diner interface of FIGS. 13A-M, wherein the diner interface enables the diner to receive a confirmation that the reservation request has been accepted by the selected restaurant.

FIG. 15B is an exemplary screenshot illustrating an alternative embodiment of the diner interface of FIG. 15A, wherein the reservation confirmation includes a confirmation sent to the diner via a text message.

FIG. 15C is an exemplary screenshot illustrating the diner interface of FIG. 15A, wherein the diner interface presents each accepted reservation of the diner.

FIG. 16A is an exemplary screenshot illustrating an alternative embodiment of the restaurant interface of FIGS. 14A-C, wherein the restaurant interface presents each reservation request that has been accepted by the restaurant and enables the restaurant to close out the reservation at the completion of meal service.

FIG. 16B is an exemplary screenshot illustrating the restaurant interface of FIG. 16A, wherein the restaurant interface enables the restaurant to close the reservation by entering a check amount for the meal service and rating the diner.

FIG. 16C is an exemplary screenshot illustrating the restaurant interface of FIG. 16A, wherein the restaurant interface enables the restaurant to complete the reservation by submitting a payment request.

FIG. 16D is an exemplary screenshot illustrating the restaurant interface of FIG. 16A, wherein the restaurant interface presents each payment request by the restaurant.

FIG. 17A is an exemplary screenshot illustrating another alternative embodiment of the diner interface of FIGS. 13A-M, wherein the diner interface presents the check amount for the meal service and enables the diner to request an itemized receipt and to rate the restaurant.

FIG. 17B is an exemplary screenshot illustrating an alternative embodiment of the diner interface of FIG. 17A, wherein the diner interface enables the diner to rate the restaurant.

FIG. 17C is an exemplary screenshot illustrating an alternative embodiment of the diner interface of FIG. 17B, wherein the diner interface enables the diner to enter rating information.

FIG. 18 is an exemplary top-level flow chart illustrating an alternative embodiment of the method for matching user requests with provider inventory of FIG. 2.

FIG. 19A is an exemplary top-level flow chart illustrating an alternative embodiment of the method of FIG. 18, wherein a user is enabled to submit a request.

FIG. 19B is an exemplary top-level flow chart illustrating an alternative embodiment of the method of FIG. 19A, wherein the user is enabled to select a request from a list of requests.

FIG. 20A is an exemplary flow chart illustrating another alternative embodiment of the method of FIG. 18, wherein the user is enabled to accept a suggestion regarding the request.

FIG. 20B is an exemplary flow chart illustrating an alternative embodiment of the method of FIG. 20A, wherein the user is enabled to accept alternative suggestions regarding the request.

FIG. 21A is an exemplary top-level flow chart illustrating still another alternative embodiment of the method of FIG. 18, wherein a provider is enabled to provide a response to the request.

FIG. 21B is an exemplary top-level flow chart illustrating an alternative embodiment of the method of FIG. 21A.

FIG. 22 is an exemplary top-level flow chart illustrating an alternative embodiment of the method of FIGS. 21A-B, wherein the provider is enabled to submit criteria for presenting a list of requests.

FIG. 23 is an exemplary top-level flow chart illustrating an alternative embodiment of the method of FIG. 22, wherein the provider is enabled to select a request from the presented list of requests.

FIG. 24 is an exemplary top-level flow chart illustrating an alternative embodiment of the method of FIG. 23, wherein the provider is enabled to evaluate the selected request.

FIG. 25A is an exemplary flow chart illustrating an alternative embodiment of the method of FIG. 24, wherein the provider is enabled to determine a disposition of a new request.

FIG. 25B is an exemplary flow chart illustrating an alternative embodiment of the method of FIG. 25A.

FIG. 26A is an exemplary flow chart illustrating another alternative embodiment of the method of FIG. 24, wherein the provider is enabled to determine a disposition of a request on a wait list.

FIG. 26B is an exemplary flow chart illustrating an alternative embodiment of the method of FIG. 26A.

FIG. 27A is an exemplary flow chart illustrating another alternative embodiment of the method of FIG. 24, wherein the provider is enabled to determine a disposition of a pending accepted request.

FIG. 27B is an exemplary flow chart illustrating an alternative embodiment of the method of FIG. 27A.

FIG. 28A is an exemplary flow chart illustrating another alternative embodiment of the method of FIGS. 21A-B, wherein the user is enabled to proceed with the request based upon the response of the provider.

FIG. 28B is an exemplary flow chart illustrating an alternative embodiment of the method of FIG. 28A, wherein the user is enabled to accept an alternative request option.

FIG. 28C is an exemplary flow chart illustrating an alternative embodiment of the method of FIG. 28B.

FIG. 28D is an exemplary flow chart illustrating another alternative embodiment of the method of FIG. 28A, wherein the response of the provider can expire and the user is enabled to request that the response be renewed after expiry.

FIGS. 29A-S are exemplary screenshots illustrating another alternative embodiment of the diner interface of FIGS. 13A-M, wherein the diner interface implements a conversation view

FIG. 30 is an exemplary diagram illustrating one embodiment of providing access levels for using the interfaces of FIGS. 13A-M and 14A-C.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION

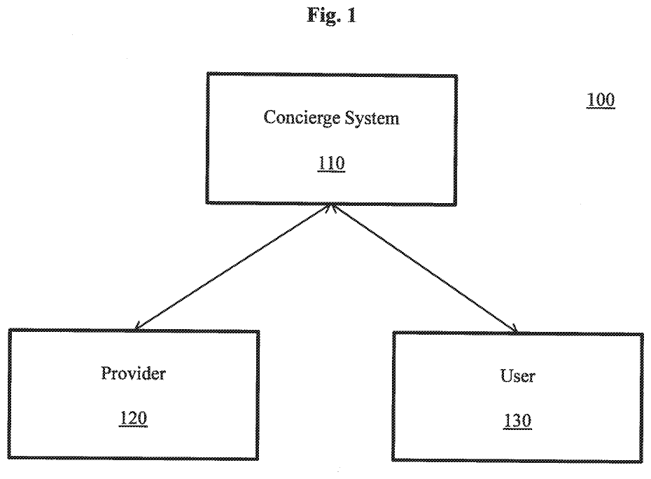

Since currently-used inventory systems are incapable of efficiently matching user requests with provider inventory, an inventory management system and method that provides comprehensive administration of the matching process by prequalifying each provider and user (or guest), suggesting providers based upon user preferences, compiling user and provider ratings and feedback, and even facilitating user payment can prove desirable and provide a basis for a wide range of inventory management applications, such as matching diner reservation requests with available table inventory in restaurant environments. This result can be achieved, according to one embodiment disclosed herein, by an inventory management system 100 as illustrated in FIG. 1.

Turning to FIG. 1, the inventory management system 100 is shown as including a concierge system 110 for communicating with a provider 120. The concierge system 110 prequalifies the provider 120 to help ensure that the provider 120 can supply a product and/or service with a quality level that meets and/or exceeds a predetermined minimum quality threshold established by the concierge system 110. In one embodiment, the concierge system 110 can condition prequalification of the provider 120 on being a well-known product and/or service provider with a superior reputation. The concierge system 110 thereby can assure that the provider 120 is credible and supplies a quality product and/or service.

The provider 120 can benefit from participating in the inventory management system 100. Participation in the inventory management system 100 can assist the provider 120 with optimizing inventory utilization and/or with gaining market share. The inventory management system 100 likewise can assist a new provider in developing a clientele and, in some cases, building a deep relationship with the clientele. By providing support for the business of the provider 120, the inventory management system 100 advantageously can exploit the common interests of the concierge system 110 and the provider 120 to foster a deep relationship between the concierge system 110 and the provider 120.

Although shown and described with reference to FIG. 1 as communicating with one provider 120 for purposes of illustration only, the concierge system 110 can communicate with, and prequalify, any suitable number of providers 120. The providers 120 can supply any conventional type of product and/or service, and the supplied product and/or service can be different and/or uniform among the providers 120. In other words, two or more of the providers 120 can be competitors that supply the same (or similar) type of product and/or service. Additionally and/or alternatively, selected providers 120 can provide different types of products and/or services so that the concierge system 110 can offer a diverse range of products and/or services.

The number of the providers 120 associated with the inventory management system 100 can change over time. For example, the concierge system 110 can elect to offer a new product and/or service and thus prequalify one or more providers 120 for supplying the new product and/or service. The provider 120 for supplying the new product and/or service can include a provider 120 that has been prequalified to provide another product and/or service and/or a new provider 120 to the inventory management system 100. Similarly, the concierge system 110 can choose to discontinue offering a selected product and/or service and thus disqualify one or more providers 120 from supplying the discontinued product and/or service. For the providers 120 that supply at least one other product and/or service other than the discontinued product and/or service, the concierge system 110 can maintain the prequalification of the provider 120 to supply the other product and/or service.

In another embodiment, the concierge system 110 can prequalify a new provider 120 if the new provider 120 begins to supply a product and/or service with a quality level that meets and/or exceeds the predetermined minimum quality threshold in the manner discussed above. The concierge system 110 likewise can disqualify a prequalified provider 120 if the prequalified provider 120 begins to supply a product and/or service with a quality level that fails to meet the predetermined minimum quality threshold. The concierge system 110 preferably recertifies each prequalified provider 120 in accordance with a quality assurance policy. For example, the concierge system 110 can periodically evaluate review data to help ensure that each prequalified provider 120 is maintaining the quality of the supplied product and/or service. Although described as supplying a product and/or service for purposes of clarity only, each provider 120 can provide any suitable number of products and/or services as long as each product and/or service satisfies the predetermined minimum quality threshold.

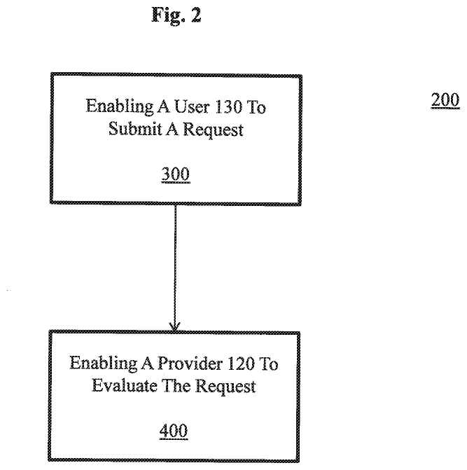

The concierge system 110 of FIG. 1 also is shown as communicating with a user (or guest) 130. The user 130 contacts the concierge system 110 with a request for one or more products and/or services. For example, FIG. 2 illustrates one user request method 200 for enabling users 130 to contact the concierge system 110 with the request. The concierge system 110 enables the user 130 to submit a request, at 300. Upon receiving the request, the concierge system 110 assumes ownership of the request and initiates fulfillment of the request. For example, the concierge system 110 enables one or more providers 120 to evaluate the request, at 400, such as by enabling a number of providers 120 to compare the request with their respective available inventory. The concierge system 110 preferably takes full responsibility for fulfilling the request with minimal, if any, further involvement by the user 130. By prequalifying the provider 120, the concierge system 110 further can assure the user 130 that the provider 120 of the requested product and/or service is credible, supplies quality products and/or services, and, in some embodiments, is a well-known provider with a superior reputation. Thereby, the concierge system 110 advantageously alleviates the user 130 from further concern regarding the request and, in some cases, can inspire a first-time user to participate in the inventory management system 100.

The request can include one or more request terms. Exemplary request terms can include conventional contract terms such as a requested product and/or service, a requested provider 120, a requested price, a requested delivery location, and/or a requested delivery time (and/or date). Advantageously, the concierge system 110 can enable the user 130 to identify multiple providers 120 in the request. In one embodiment, the user 130 can identify an initial provider 120 for the request and subsequently can add one or more additional providers 120. Additionally and/or alternatively, the user 130 can identify the multiple providers 120 at the same time. The user 130 thereby need not again specify the other request terms that are common to the requests to be communicated to the providers 120.

By enabling the user 130 to identify multiple providers 120, the concierge system 110 can communicate the same request to each identified provider 120, maximizing the likelihood that the request will be fulfilled while minimizing the effort required of the user 130. If one of the multiple providers 120 accepts the request, the concierge system 110 preferably inhibits any of the other multiple providers 120 from also accepting the request. The concierge system 110 thereby can prevent more than one provider 120 from accepting the request. In one embodiment, the concierge system 110 can block the other multiple providers 120 from viewing and/or accessing the request.

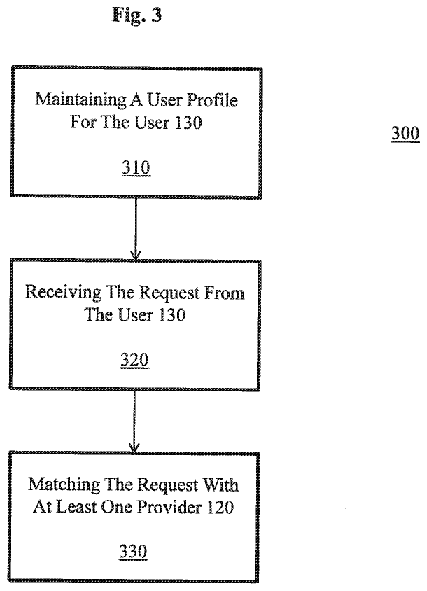

In some embodiments, one or more of the request terms can be provided as a range. The requested delivery date, for example, can include a range of requested delivery dates, a requested delivery time on the requested delivery date, and/or a selected range of requested delivery times on the requested delivery date. The concierge system 110 considers the request terms in initiating fulfillment of the request. Turning to FIG. 3, additionally and/or alternatively, the concierge system 110 can maintain a user profile of the user 130, at 310, and can consider the user profile information in initiating fulfillment of the request. Accordingly, the concierge system 110 can receive the request from the user 130 that includes the user profile for the user 130, at 320. This user profile can be used to identify one or more providers 120 that match the user request, at 330.

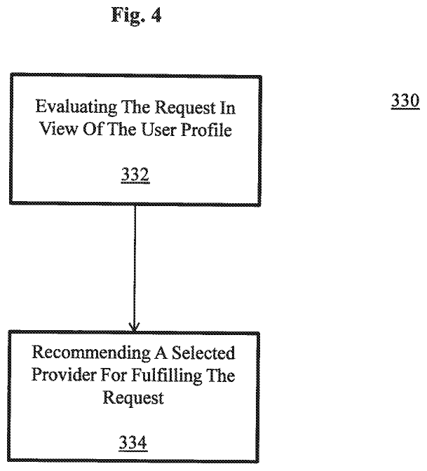

Turning to FIG. 4, the concierge system 110 receives the request from the user 130 and evaluates the request in view of the user profile, at 332. Based on the user profile, the concierge system 110 advantageously can recommend a selected provider from the providers 120 to fulfill the request.

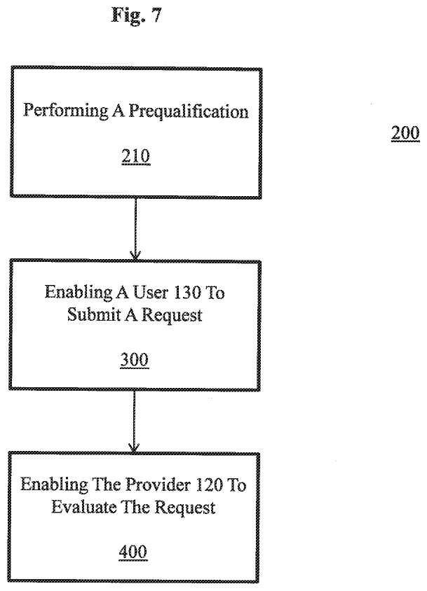

Additionally and/or alternatively, the user profile can be used to prequalify the user 130. Turning to FIG. 7, the request method 200 (shown in FIG. 2) can also include a prequalification, at 210. Stated somewhat differently, the concierge system 110 can use the user profile information to prequalify the user 130. Typical user profile information can include information regarding interests, behavior and/or preferences of the user 130. The concierge system 110 thereby can prequalify the user 130 by assigning a user status, such as preferred user and/or new user, to the user 130. In one embodiment, the concierge system 110 can maintain the user profile of the user 130 and, if the user 130 is not prequalified, the provider 120 can consider the user profile information in determining whether to fulfill the request, at 400. In other words, if the user 130 is not prequalified, the concierge system 110 can allow the provider 120 to review the request, develop insight into the user based upon the available user profile information, and then confirm, leave pending, or deny the request, as desired.

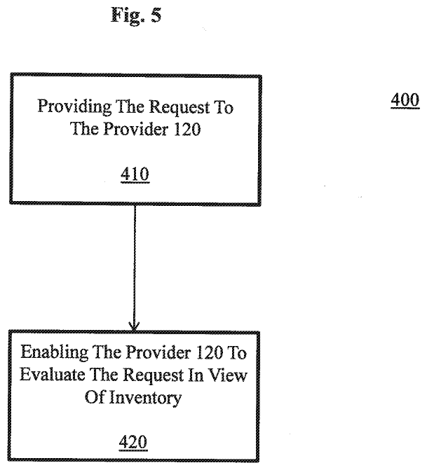

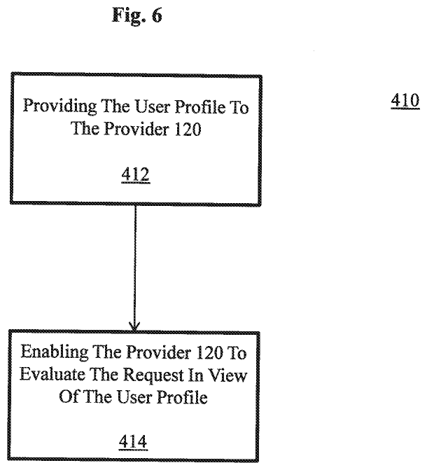

For example, turning to FIG. 5, the concierge system 110 provides the user request to the provider 120, at 410. Specifically, with reference to FIG. 6, the concierge system 110 provides the user request that includes the user profile, at 412. The provider then can evaluate the entire request in view of the user profile, at 414. Returning to FIG. 5, the provider 120 can evaluate the selected request in any suitable manner, including for example, in view of the current inventory of the provider 120, at 420. The provider 120 preferably evaluates the selected request in an effort to determine a disposition for the selected request.

In one embodiment, the concierge system 110 can further enhance the user's experience by enabling the user 130 to include specific request details, such as expedited fulfillment and/or an exceptional product and/or service, among the request terms. If the user 130 requests a rare or otherwise exceptional product, for example, the concierge system 110 can present the user 130 with an opportunity to offer a pricing premium to the provider 120. The user 130 can accept or decline to include the pricing premium offer in the request, and/or the provider 120 can agree or refuse to accept an offer from the user 130 to pay pricing premiums.

If the user 130 and the provider 120 agree to engage in the pricing premiums, the pricing premium offer can be presented in any conventional manner and preferably comprises a bid on the exceptional product. The bid can include any additional amount of money that the user 130 is willing to pay the provider 120 to receive the exceptional product. Although any accepted bid amount can be provided in its entirety to the provider 120, the concierge system 110 and the provider 120 can share the accepted bid amount in a preferred embodiment. The accepted bid amount can be divided between the concierge system 110 and the provider 120 in any conventional manner. For example, the concierge system 110 can receive a predetermined amount (or percentage) of the accepted bid amount; whereas, the balance of the accepted bid amount is provided to the provider 120.

In one embodiment, the bid can be presented as a predetermined percentage (and/or a predetermined percentage range) of the list price of the exceptional product. The predetermined percentage can include any percentage between zero percent (no premium) and one hundred percent (or more) of the list price. The concierge system 110 can enable the user 130 to present the predetermined percentage as a discrete percentage value and/or in preselected percentage increments. The preselected percentage increments can comprise any suitable uniform and/or different increments and, in one embodiment, can be ten percent increments.

To facilitate the bidding process, the concierge system 110 can compile statistics based upon historical bid rates and/or demand for the provider 120. The provider 120, for example, can provide the concierge system 110 with one or more conditions during which requests with user bids are accepted. Additionally and/or alternatively, the concierge system 110 can gather user demand data for the provider 120 and recommend one or more conditions under which the provider 120 could advantageously enable the users 130 to include bids with the requests. Based upon the condition information, the concierge system 110 can gather data regarding bid rates that the provider 120 previously accepted when the conditions were met. The accepted bid rates can be uniform and/or can differ based, for example, upon differences among the relevant conditions. The concierge system 110 thereby can compare the request terms of the user 130, determine whether the request terms meet a selected condition, and, if so, suggest a bid rate to the user 130 based upon the accepted bid rates when the selected condition is satisfied.

Although discussed in terms of pricing premiums for purposes of illustration only, the request alternatively can include an offer to pay a reduced price for the product and/or service. The reduced price offer may be appropriate, for example, if the requested product and/or service are less exclusive and/or are in lower demand. The user 130 can present the reduced price offer to the provider 120 in the same manner in which the pricing premium offer is presented. In one embodiment, the concierge system 110 can make the bidding process available for all requests. Additionally and/or alternatively, the bidding process can be made available only under predetermined conditions, such as for requests for a product and/or service that is scarce and/or in high demand.

Additionally and/or alternatively, the inventory management system 100 can apply a predetermined pricing premium (or discount) to the list price of the requested product and/or service if at least one selected condition is met. In other words, the predetermined pricing premium (or discount) is applied to the list price without instituting a bidding process. The predetermined pricing premium (or discount) can apply to a preselected group of users 130 or uniformly to all users 130. The predetermined pricing premium (or discount) can comprise a predetermined dollar amount and/or a predetermined percentage of the list price. Exemplary conditions under which the inventory management system 100 can apply the predetermined pricing premium (or discount) include a time period during which the requested product and/or service is in high demand, the requested product and/or service is scarce, and/or other market factors that can affect pricing.

In one embodiment, the predetermined pricing premium (or discount) comprises an adjustable pricing premium (or discount), wherein a first predetermined pricing premium (or discount) is applied when the condition is satisfied and a second predetermined pricing premium (or discount), being less than the first predetermined pricing premium (or discount), is applied when the condition is on the verge of being satisfied. Stated somewhat differently, the selected condition can comprise a first condition and a second condition that is related to the first condition. The first predetermined pricing premium (or discount) is applied when the first condition is satisfied, and the second predetermined pricing premium (or discount) is applied when the second condition is satisfied. For example, the first condition can be satisfied if the request terms include a delivery time during a time of high demand for the selected product and/or service; whereas, the second condition can be satisfied if the request terms include a delivery time during a time of medium demand.

If the selected condition includes a third condition that also is related to the first condition, a third predetermined pricing premium (or discount), being less than the first predetermined pricing premium (or discount), can be applied when the third condition is satisfied. In other words, the second and/or third conditions may be associated with opposite boundaries of the first condition. For example, the second condition can be satisfied if the request terms include a delivery time during an initial time of medium demand that precedes a period of high demand for the selected product and/or service, and the third condition can be satisfied if the request terms include a delivery time during a later time of medium demand that follows the period of high demand. The second predetermined pricing premium (or discount) can be greater than, less than, or equal to the third predetermined pricing premium (or discount).

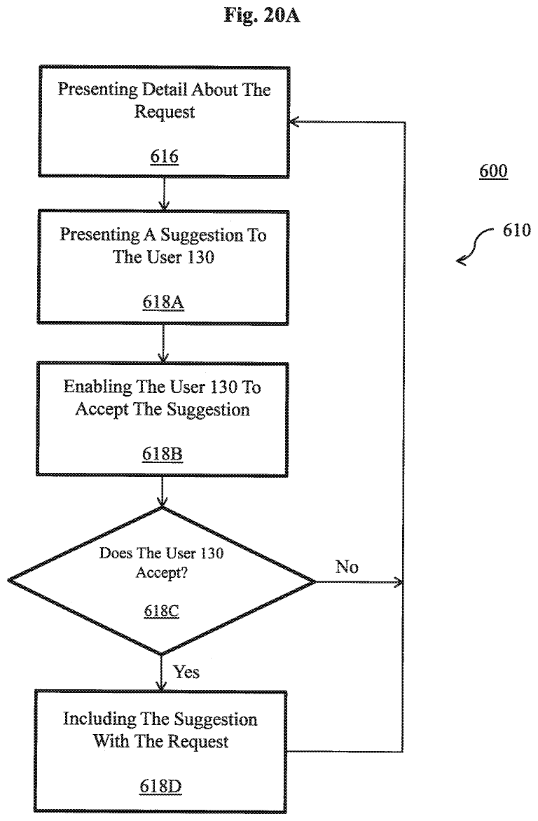

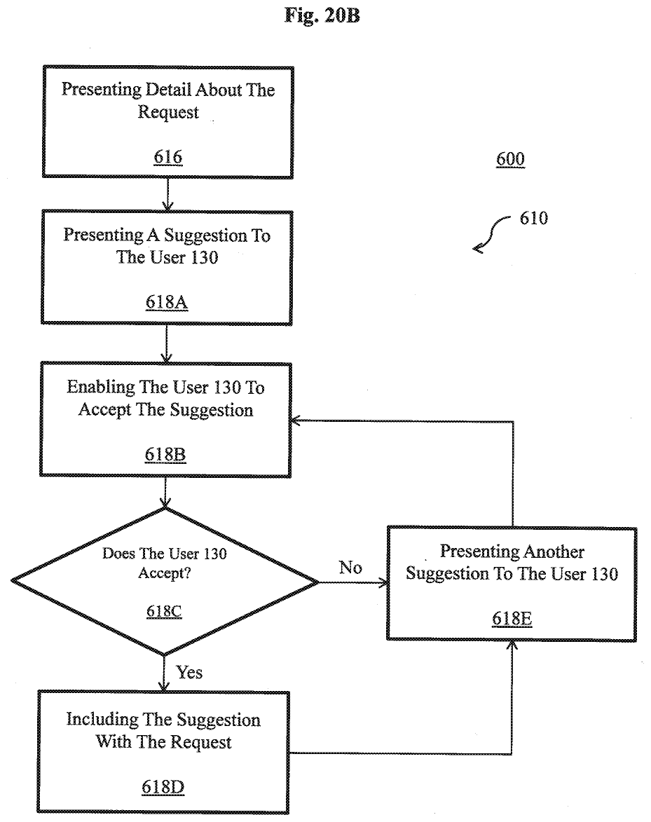

If the request identifies one or more requested providers 120, for example, the concierge system 110 can communicate the request to each requested provider 120. Additionally and/or alternatively, the concierge system 110 can provide the user 130 with at least one recommendation of a provider 120 suitable for fulfilling the request as discussed in further detail below with reference to FIGS. 20A-B. Each recommendation can be based at least in part of the request and/or the user profile information of the user 130. The concierge system 110 preferably communicates the request to the provider 120 in real time (or with as little time latency as is possible under the circumstances).

The concierge system 110 advantageously can make intelligent recommendations for guiding the users 130 to request products and/or services that the users 130 did not know that they wanted. Thereby, the concierge system 110 can set the expectations of the users 130 that the concierge system 110 can provide personalized service, reinforcing core brand attributes with exceptional hospitality, in a manner that is scalable and reduces workload for operations. By enabling the providers 120 and the users 130 to communicate directly, the concierge system 110 advantageously bridges the gap between the providers 120 and the users 130. The concierge system 110 likewise can redirect traffic from higher-demand providers 120 to other providers 120 associated with the concierge system 110.

Each provider 120 can consider the request and decide whether and, if so, how to accommodate the request. In other words, the inventory management system 100 enables each provider 120 to employ a “demand-side” inventory management system for evaluating the request. The demand-side inventory management system enables the provider 120 to receive requests that indicate inventory demand in contrast to a supply-side inventory management system under which the inventory is listed and filled without insight into user demand. In one embodiment, the request can be accompanied by the user profile information of the user 130, enabling the provider 120 to evaluate the user profile information when considering and/or fulfilling the request. Additionally and/or alternatively, the provider 120 can assign certain inventory to be filled if the request matches certain request parameters, which is discussed further below.

If the concierge system 110 has prequalified the user 130, the provider 120 can base the decision of whether to fulfill the request based at least in part on the user status of the user 130. The provider 120, for example, can automatically fulfill the request if the user 130 has a preferred user status and sufficient inventory is available; whereas, if the user 130 has a new user status, the request is not automatically fulfilled but, instead, undergoes the evaluation process by provider 120. The concierge system 110 thereby can enable the provider 120 to dynamically manage its inventory in an intelligent manner and/or to better satisfy the user 130 when fulfilling the request. Advantageously, participation in the inventory management system 100 does not require the provider 120 to accept the request and/or designate (or otherwise set aside) any inventory for the benefit of the inventory management system 100 in advance of receiving the request.

To enable the provider 120 to intelligently manage its inventory, at least one request term of the request preferably is provided as a range of request terms. The requested delivery date, for example, can be provided as a range in the manner set forth above. Thereby, the provider 120 can determine inventory status at each time (and/or date) within the range, enabling the provider 120 to select any time (and/or date) within the range for fulfilling the request. Advantageously, even if the provider 120 does not have sufficient inventory to fulfill the request at the time that the request is received, the request can be marked as reviewed and included on a “cancellation wait list” of the provider 120. Thereby, if additional inventory becomes available at a later time between receipt of the request and a time (and/or date) within the range due, for example, to cancellation of an inventory reservation by another user, the provider 120 can retrieve the pending request from the cancellation wait list and accept the retrieved request. The demand-side inventory system thus enables the provider 120 to subsequently accept the request despite the earlier lack of inventory. In other words, the demand-side inventory system of the inventory management system 100 can keep the request pending, enabling the user 130 to “stand in line” to receive the requested product and/or service if inventory later becomes available.

Upon determining that the request cannot presently be accepted and will be added to the cancellation wait list or otherwise kept pending, the concierge system 110 can communicate the status of the pending request to the user 130. The concierge system 110 likewise can inform the user 130 of one or more options for proceeding with the pending request. Exemplary options can include leaving the pending request pending in case of a cancellation, adding one or more additional providers 120 to the pending request, and/or cancelling the pending request entirely. Advantageously, as the concierge system 110 maintains an updated inventory of all providers 120, one or more options can be provided to the user 130 that can be automatically booked. Similarly, if a selected provider 120 is part of a group of providers 120, the user 130 can also view and select availability of one more providers 120 of the group.

By adding the additional providers 120 to the pending request, the chances of the request being accepted by one of the providers 120 increases. The concierge system 110 can remove the pending request from the cancellation wait list of the initial provider 120 if another provider 120 accepts the pending request or if the user 130 cancels the pending request.

Additionally and/or alternatively, the provider 120 can present a counteroffer to the request. The counteroffer can be presented to the concierge system 110 and/or the user 130. In other words, the concierge system 110 can communicate the counteroffer to the user 130 for consideration and/or can respond to the counteroffer on behalf of the user 130 based upon the user profile of the user 130. The user 130 can accept or decline the counteroffer made by provider 120. Continuing with the above example, if the provider 120 does not have sufficient inventory to fulfill the request within the time (and/or date) range set forth in the request, the provider 120 can present a counteroffer to fulfill the request on a time (and/or date) outside of the range.

The provider 120 also can decline or accept the request. If the provider 120 elects to decline the request, the provider 120 can communicate a rejection to concierge system 110, which can inform the user 130 of the rejection and/or provide at least one recommendation of an alternate provider 120 to the user 130 in the manner set forth above. Alternatively, if the provider 120 elects to fulfill the request, the provider 120 can communicate an acceptance to the concierge system 110. The acceptance preferably includes a confirmed delivery time (and/or date) for fulfilling the request. The concierge system 110 can inform the user 130 of the acceptance, including the confirmed delivery time (and/or date). The provider 120 can communicate the decision to accept or reject the request to the concierge system 110 and/or the user 130 as soon as the decision is made and preferably within a predetermined time period after receiving the request (and with as little time latency as is possible under the circumstances).

In one embodiment, the user 130 can invite one or more guests to participate in the request. The user 130, in other words, can offer to share the requested products and/or services with the guests. The user 130 can invite the guests at any time before the confirmed delivery time, including at the time when the user 130 communicates the request to the concierge system 110 and/or at the time when the user 130 receives the request acceptance from the concierge system 110. The user 130 preferably sends an invitation to each guest via the concierge system 110. For any invitations sent before the provider 120 accepts the request, the concierge system 110 can inform the relevant guests of the acceptance, including the confirmed delivery time (and/or date), in the manner discussed above.

Advantageously, the concierge system 110 can provide the provider 120 with user profile information for each invited guest who has a user profile in the inventory management system 100. Additionally and/or alternatively, the concierge system 110 can analyze the user profile information of the user 130 and the user profile information of the guests to generate a collective profile and can provide the collective profile to the provider 120. The provider 120 thereby can evaluate the user profile information of the user 130 and the guests individually and/or collectively when considering and/or fulfilling the request in an effort to maximize the individual and/or collective experiences while optimizing inventory utilization for the provider 120.

The concierge system 110 can provide one or more reminders and/or confirmations about the accepted request to the provider 120 and/or the user 130 (and any guests of the user 130) in advance of the confirmed delivery time (and/or date). Each confirmation can require a confirmation response from the user 130, advantageously alleviating the provider 120 of placing a conforming telephone call the user 130 in advance of the confirmed delivery time. The provider 120 and/or the user 130 can cancel the accepted request at any time before the confirmed delivery time. Although the cancelling party can communicate the cancellation to the other party directly, the cancelling party preferably communicates the cancellation to the concierge system 110, which informs the other party.

In one embodiment, the reservation request can be subject to a cancellation policy. The cancellation policy can comprise a default cancellation policy of the inventory management system 100 and/or can be based upon a cancellation policy specific to the provider 120. In one embodiment, the concierge system 110 can assess a cancellation fee to the user 130 if the user 130 fails to be available at (or within a predetermined time period after) the confirmed delivery time and/or does not timely communicate the cancellation to the concierge system 110 and/or the provider 120. The cancellation can be deemed to be untimely if communicated to the concierge system 110 and/or the provider 120 after a predetermined cancellation deadline. The predetermined cancellation deadline can be determined in any conventional manner and can be based on, for example, on a predetermined number of hours (or days), such as four hours, before the confirmed delivery time. Additionally and/or alternatively, the cancellation can be deemed to be untimely if communicated to the concierge system 110 and/or the provider 120 after the concierge system 110 sends a selected reminder and/or confirmation.

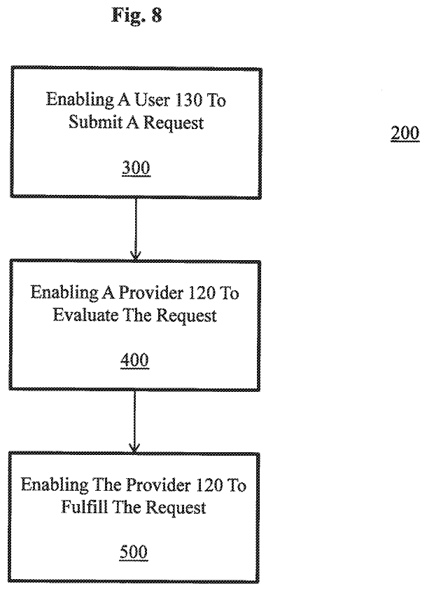

The request method 200 (shown in FIG. 2) preferably enables a selected provider 120 to fulfill the request. Turning to FIG. 8, at the confirmed delivery time (and/or date), the provider 120 begins to fulfill the request, at 500. The user 130 (and any guests of the user 130) thereby receives the requested product and/or service. Advantageously, if the request is accompanied by the user profile information of the user 130 (and any guests of the user 130), the provider 120 can personalize the manner by which the request is fulfilled. The provider 120, for example, can address the user 130 by name and/or customize the fulfillment to the user 130 based upon the provided user profile information.

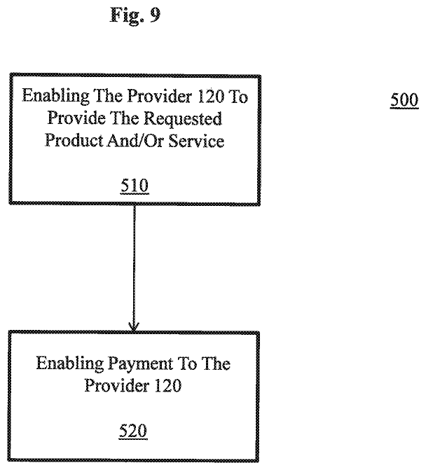

Enabling the provider 120 to fulfill the request, at 500, preferably includes an exchange for the requested product and/or service for payment, such as shown in FIG. 9. Turning to FIG. 9, the concierge system 110 enables the provider 120 to provide the requested product and/or service, at 510. Once the requested product and/or service has been provided to the user 130, the concierge system 110 enables payment to the provider 120, at 510.

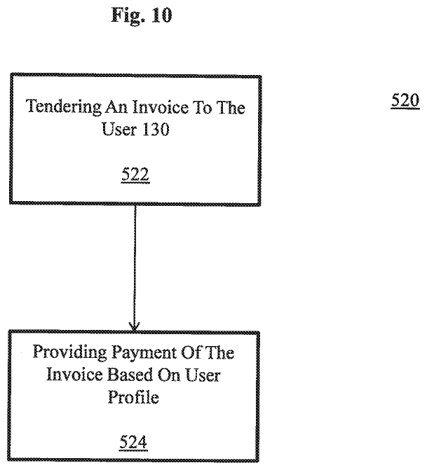

For example, turning to FIG. 10, fulfillment of the request is consummated by the provider 120 tendering a detailed and/or summary invoice to the user 130, at 522. The invoice can be presented directly to the user 130 and/or, in a preferred embodiment, indirectly to the user 130 via the concierge system 110. If the request involves supplying a service and the user 130 is present to receive the requested service, for example, the provider 120 can hand the invoice to the user 130. Alternatively, if the request involves shipping a product to the user 130, the invoice can be included with the shipment. The invoice preferably is tendered electronically such as via electronic mail (or email) to a user email address included in the user profile of the user 130. If the user 130 is accompanied by any guests, the user 130 and the guests can agree to split the invoice amount in any mutually-acceptable manner. The provider 120 therefore can prepare the split invoice in accordance with the mutually-acceptable manner and can tender the respective invoices in the manner set forth above.

The invoice can include a price of the product and/or service. Additionally and/or alternatively, the invoice can include a tip, any taxes, and any surcharges, such as any pricing premium (or pricing reduction), any service fee, and any other charges, in accordance with the terms of the request and/or the user profile information for the user 130. In one embodiment, the user profile for the user 130 advantageously can include a standard (and/or default) tip rate; whereas, the concierge system 110 can determine relevant tax rate(s) for the product and/or service based upon the location of the provider 120. By applying the request terms of the request and/or the user profile information for the user 130, the concierge system 110 thereby can automatically generate the invoice without requiring interaction from either the provider 120 and/or the user 130.

To facilitate the electronic tendering of the invoice, the concierge system 110 can communicate with a point of sale (POS) system or other sale management software of the provider 120. Although preferably integrated with the sale management software for automatic communications, the inventory management system 100 can include a provider interface, such as a provider computer system as discussed in more detail below, for enabling the provider 120 to process the transaction without being coupled with the sale management software. In one embodiment, the provider interface can enable the provider 120 to manually enter the price information from the POS system and can provide other transaction information, such as a tip amount, for manual entry into the POS system. The transaction thereby can be closed out to a house account (or tender) of the inventory management system 100.

The user profile information for the user 130 preferably includes payment information. Exemplary payment information can include any conventional type of payment information, such as a credit card number, a debit card number, and/or a checking account number. In a preferred embodiment, the payment information enables payment to be processed via the Automated Clearing House (ACH) system. By using the ACH system, the user 130 does not receive any credit card points for the transaction but can deem the overall experience provided by the inventory management system 100 to be more valuable than the credit card points. Further, use of the ACH system enables the provider 120 to increase revenue from the transaction by avoiding the credit card fees. Accordingly, the user 130 and the provider 120 both receive a benefit from the inventory management system 100.

Once the request has been fulfilled, the concierge system 110 can submit a payment request on behalf of the provider 120 based upon the payment information of the user 130, at 524. In other words, the concierge system 110 can handle payment submission for the requested product and/or service such that the provider 120 and user 130 are relieved from initiating the financial transaction and the related processing latencies. The provider 120 advantageously can consummate the request more efficiently and use the time savings to assist other customers; whereas, the user 130 can engage in a subsequent activity without delay. The concierge system 110 likewise can record fulfillment information, such as an elapsed time, related to fulfillment of the request, and can provide the fulfillment information to the provider 120. Accordingly, the inventory management system 100 can seamlessly manage the transaction for the product and/or service from request to payment in a manner that benefits both the provider 120 and the user 130.

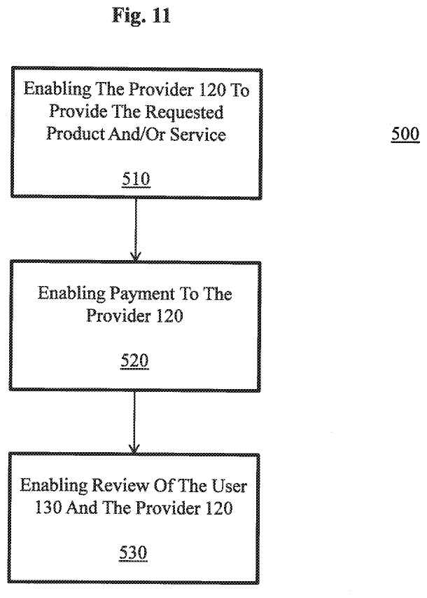

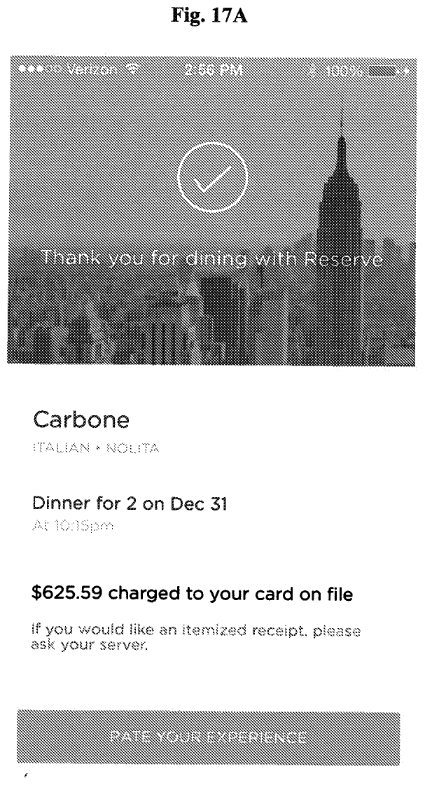

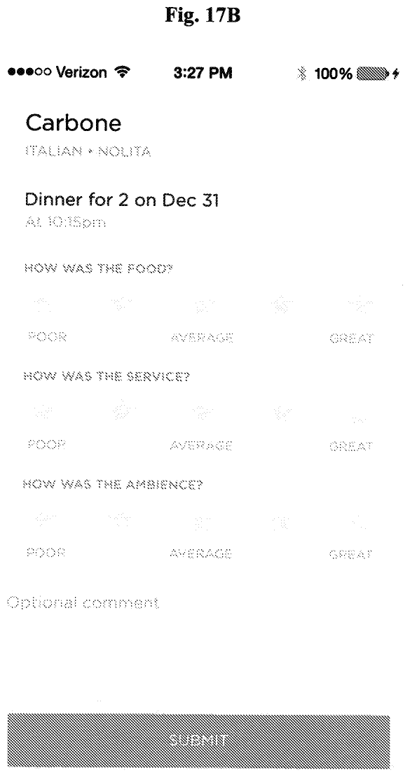

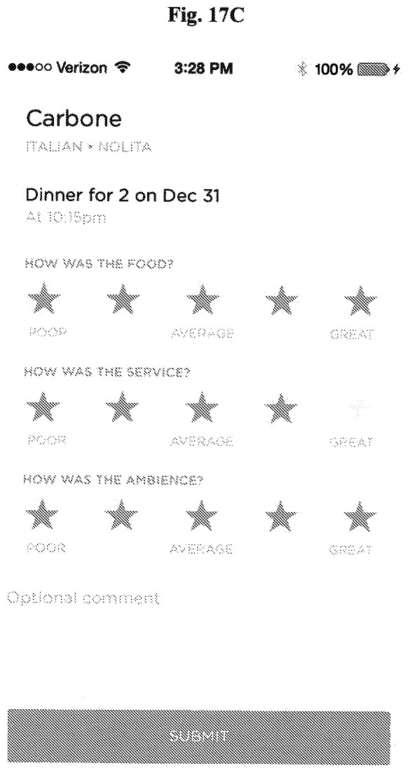

Consummating the request can include the user 130 providing the concierge system 110 with review (or feedback) information about the provider 120 regarding the transaction for the product and/or service, such as shown in FIG. 11. In one embodiment, the user 130 can be required to review the provider 120, at 530. If the user 130 communicates with the concierge system 110 via a software application, for example, a rating screen can be presented when the user 130 opens the software application after the transaction has been concluded (shown in FIGS. 17A-C). The rating screen can enable the user to enter rating information regarding the concluded transaction. The software application preferably requires the user 130 to complete the review by inhibiting the user 130 from entering another request or otherwise utilizing the software application until the review of the concluded transaction is completed.

The review can occur at any convenient time after the request has been consummated and preferably before a predetermined amount of time elapses to help ensure that the user 130 can provide an accurate review of the provider 120. The review information from the user 130 enables the concierge system 110 to receive feedback from the user 130 who has actually completed a transaction with the provider 120. The review information advantageously enables the concierge system 110 to confirm that the provider 120 continues to satisfy the predetermined minimum quality threshold established by the concierge system 110. Further, the provider 120 can improve service to its customers based upon the review information.

Additionally and/or alternatively, consummating the request can include the provider 120 providing the concierge system 110 with review (or feedback) information about the user 130 regarding the transaction for the product and/or service, also shown in FIG. 11, at 530. In one embodiment, the provider 120 is required to review the user 130 contemporaneously with the consummation of the request. The provider 120 likewise can provide other user information, such as user preference information and other metadata, about the user 130 at that time. The review information from the provider 120 enables the concierge system 110 to receive immediate feedback from the provider 120 who has actually completed a transaction with the user 130. The review information advantageously enables the concierge system 110 to update the user profile of the user 130 to include the review and/or other user information.

Accordingly, the inventory management system 100 can enable the user 130 to provide a request that describes a desired transaction for a product and/or service. The concierge system 110 can consider the request in view of the preferences (and other user profile information) of the user 130, the preferences (and other user profile information) of any guests of the user 130, the preferences (and other user profile information) of other users who have preferences that are the same (or similar) to the preferences of the user 130 (and any guests of the user 130), and/or the profiles of the prequalified providers 120. Thereby, the concierge system 110 can provide the user 130 with at least one recommendation of a provider 120 suitable for fulfilling the request. Once a selected provider 120 fulfills the request, the concierge system 110 can compare the expectations of the user 130 with the review (or feedback) information that the user 130 provides about the provider 120 regarding the transaction. As the user 130 concludes additional transactions via the inventory management system 100, the concierge system 110 can provide successively better recommendations and other services to the user 130 and/or include more current, relevant, and actionable user profile information to the provider 120 with a subsequent request from the user 130. In an embodiment, the current, relevant, and actionable user profile information of the user 130 can be provided, in whole or in part, with a later request from the user 130 to another provider 120.

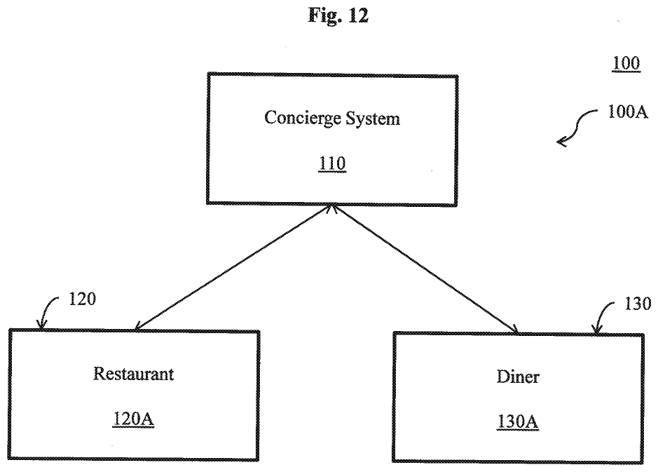

Although shown and described with reference to FIG. 1 as comprising a concierge system 110 for matching user requests with provider inventory for purposes of illustration only, the inventory management system 100 can be readily applied for managing any conventional types of transactions, including any conventional type of concierge services. In one exemplary embodiment, the inventory management system 100 can be readily applied to a restaurant environment. When applied to the restaurant environment, the inventory management system 100 can be provided as a restaurant inventory management system 100A in the manner illustrated in FIG. 12. The restaurant inventory management system 100A of FIG. 12 is shown as being directed toward a fulfilling request for dining services for purposes of illustration only and not for purposes of limitation.

In the manner discussed in more detail above with reference to FIG. 1, the restaurant inventory management system 100A is shown as including a concierge system 110 for communicating with an operator of a restaurant 120A and a potential diner (or guest) 130A. The concierge system 110 prequalifies the restaurant 120A to help ensure that the restaurant 120A can supply a dining experience with a quality level that meets and/or exceeds a predetermined minimum quality threshold established by the concierge system 110. In one embodiment, the concierge system 110 can condition prequalification of the restaurant 120A on being a well-known restaurant with a superior reputation. The concierge system 110 thereby can assure the diner 130A that the restaurant 120A is credible and supplies a quality dining experience before, during and after a meal.

The restaurant 120A can benefit from participating in the restaurant inventory management system 100A. Participation in the restaurant inventory management system 100A can assist the restaurant 120A with optimizing table inventory utilization, which can be advantageous for restaurants with limited table inventories, for example, due to high diner demand. The restaurant inventory management system 100A likewise can assist a new restaurant in developing a loyal group of regular diners, gaining market share, and in some cases, building a deep relationship with diners. By providing support for the restaurant 120A, the restaurant inventory management system 100A advantageously can exploit the common interests of the concierge system 110 and the restaurant 120A to foster a deep relationship between the concierge system 110 and the restaurant 120A.

Although shown and described with reference to FIG. 12 as communicating with one restaurant 120A for purposes of illustration only, the concierge system 110 can communicate with, and prequalify, any suitable number of restaurants 120A. Each restaurant 120A can provide a selected type of dining experience. The dining experience can depend upon selected restaurant attributes, including, for example, cuisine, quality ingredients, experienced chef, menu options, attentive wait staff, dining ambience, and/or extras. The restaurant attributes can be different and/or uniform among the restaurants 120A. In other words, two or more of the restaurants 120A can be competitors that supply the same (or similar) restaurant attributes. Additionally and/or alternatively, two or more restaurants 120A can provide different restaurant attributes such that the concierge system 110 can offer a diverse range of dining experiences.

In the manner set forth above with reference to FIG. 1, the number of the restaurants 120A associated with the restaurant inventory management system 100A can change over time. For example, the concierge system 110 can prequalify a new (or additional) restaurant 120A if the new restaurant 120A begins to supply a dining experience with a quality level that meets and/or exceeds the predetermined minimum quality threshold as discussed above. The concierge system 110 likewise can disqualify a prequalified restaurant 120A if the prequalified restaurant 120A begins to supply a dining experience with a quality level that fails to meet the predetermined minimum quality threshold. The concierge system 110 preferably recertifies each prequalified restaurant 120A in accordance with a quality assurance policy. In one embodiment, the concierge system 110 can periodically evaluate review data to help ensure that each prequalified restaurant 120A is maintaining the quality of the dining experience.

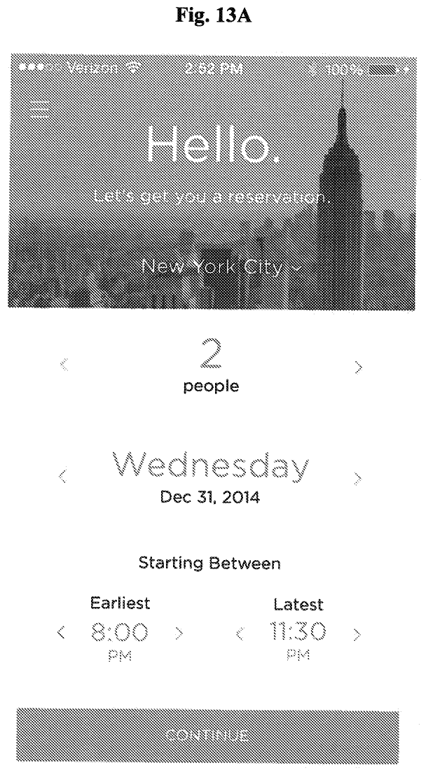

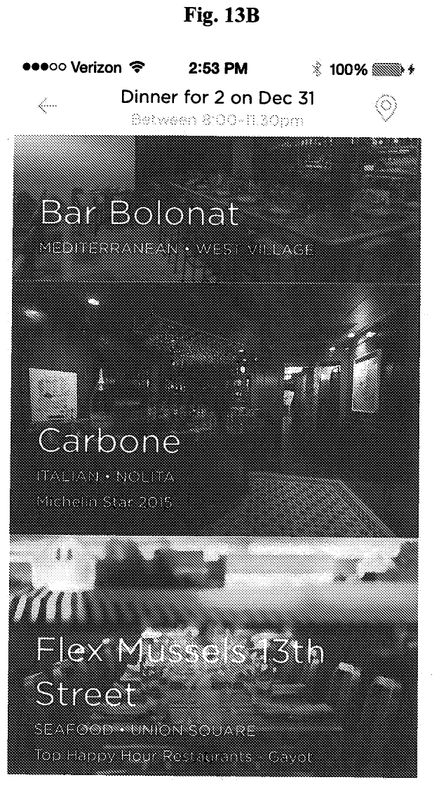

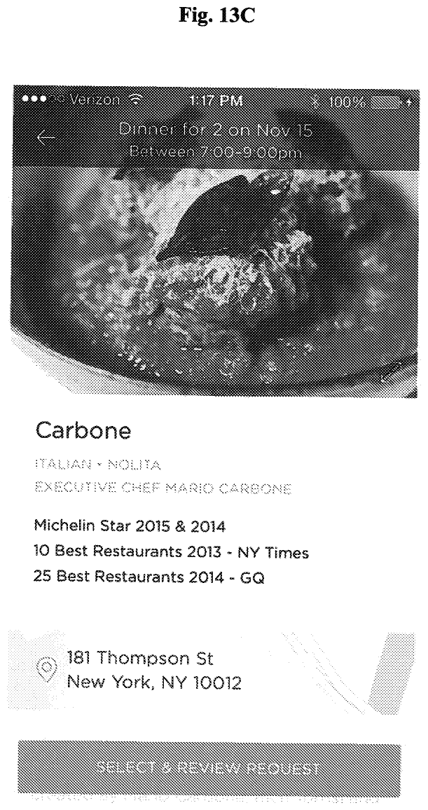

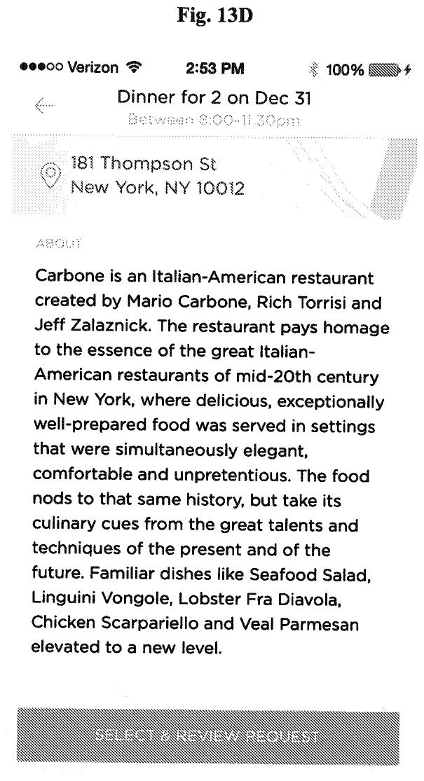

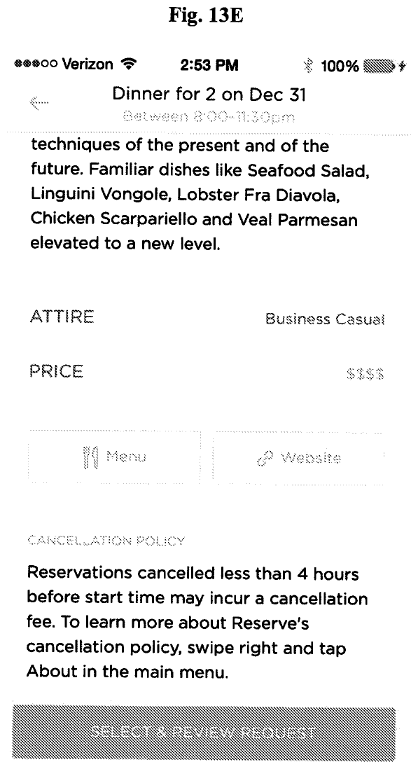

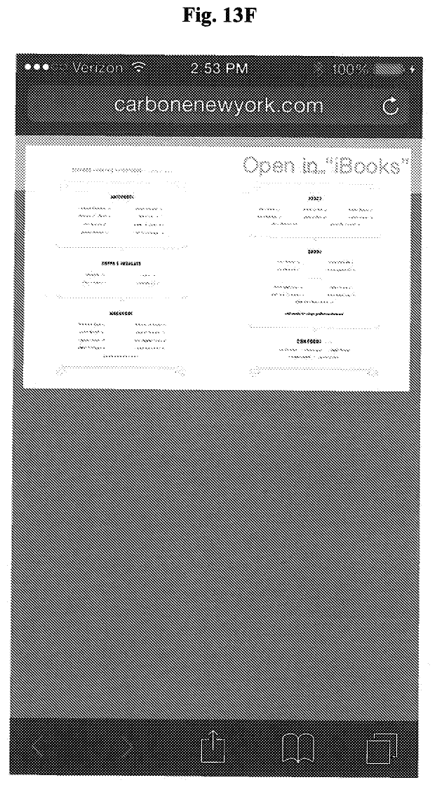

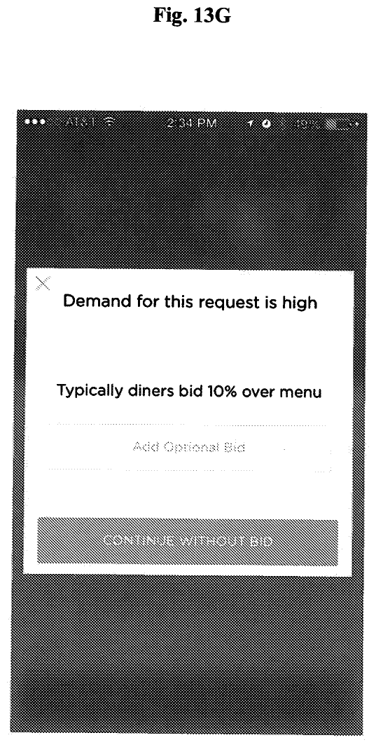

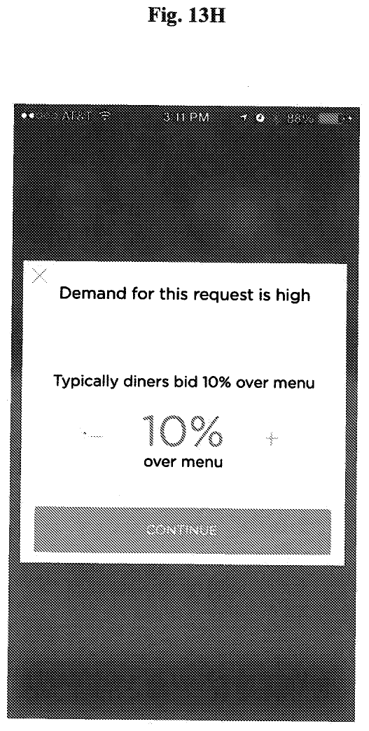

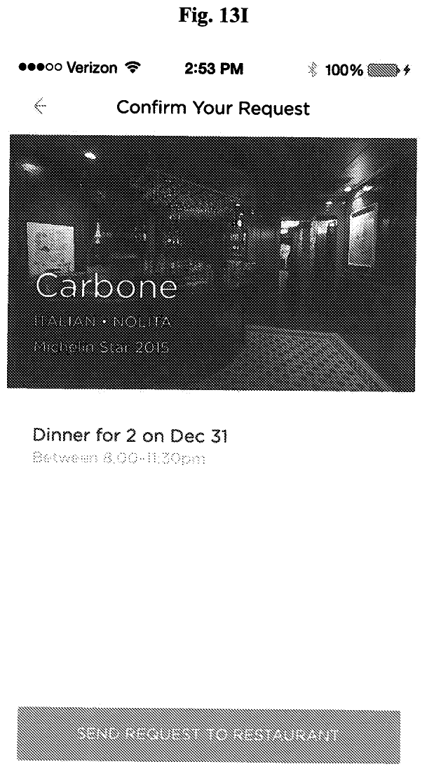

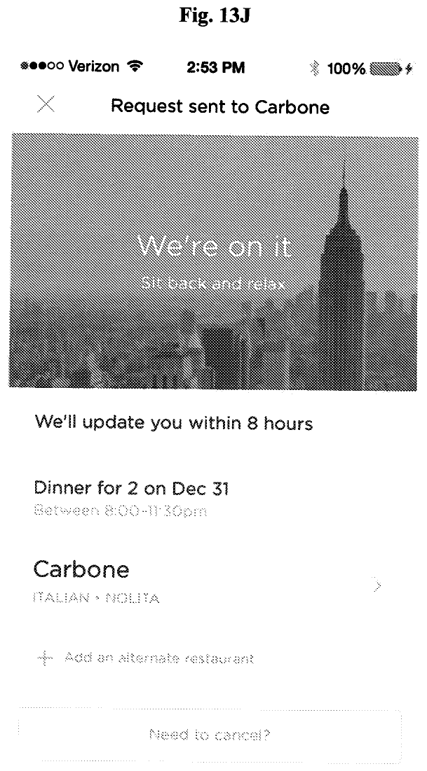

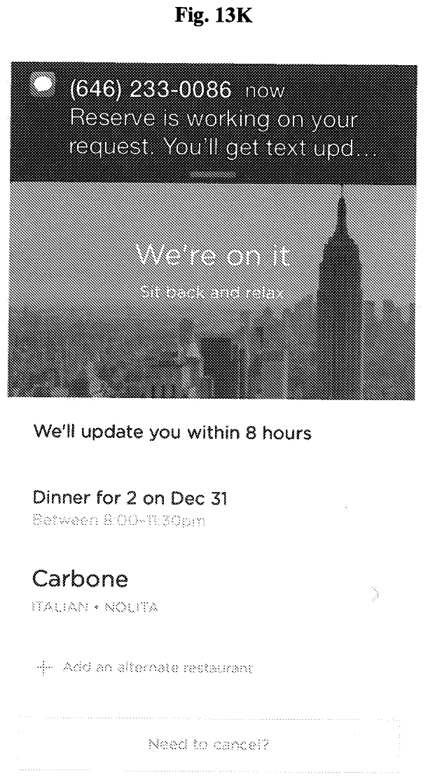

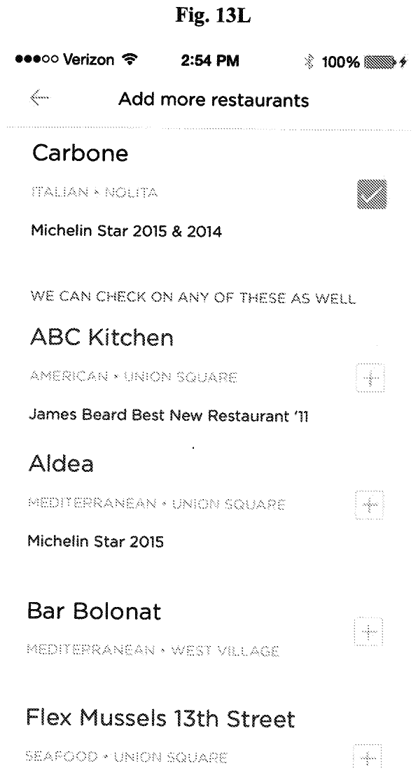

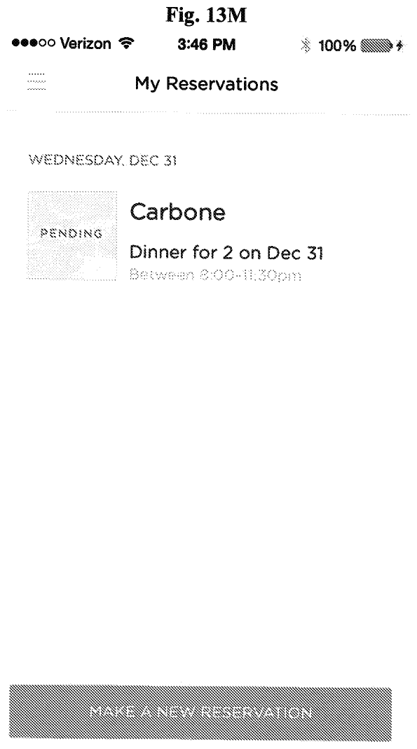

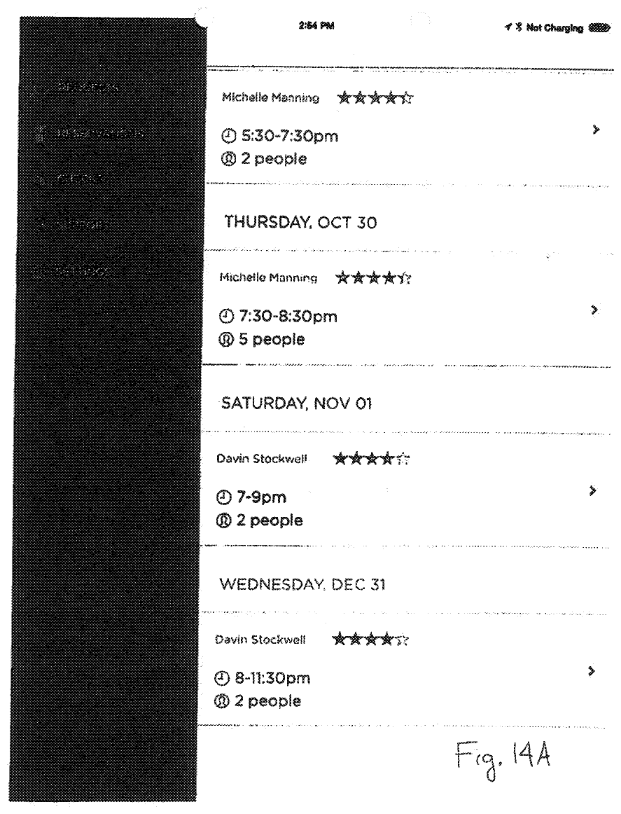

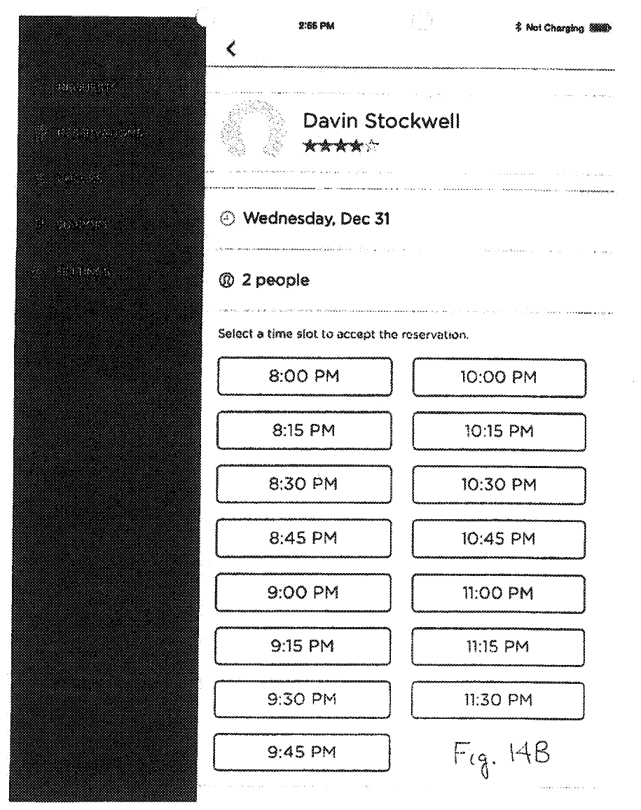

Upon wishing to enjoy a quality dining experience, the diner 130A contacts the concierge system 110 with a reservation request (shown in FIGS. 13A-E). Upon receiving the reservation request, the concierge system 110 assumes ownership of the reservation request and initiates fulfillment of the reservation request. The concierge system 110 preferably takes full responsibility for fulfilling the reservation request with minimal, if any, further involvement by the diner 130A. For example, the concierge system 110 can provide the diner 130A with a confirmation screen once the request has been sent with no additional actions required on the part of the diner 130A (shown in FIGS. 13J-K and 15B). Due to the restaurant prequalification process, the concierge system 110 further can assure the diner 130A that each restaurant 120A associated with the restaurant inventory management system 100A is credible, supplies a quality dining experience, and, in some embodiments, is a well-known restaurant with a superior reputation. Thereby, the concierge system 110 advantageously alleviates the diner 130A from further concern regarding the reservation request and, in some cases, can inspire a first-time diner to participate in the restaurant inventory management system 100A.

The reservation request can include one or more reservation terms. Exemplary reservation terms can include a selected restaurant 120A, a cuisine type, a meal price, an ambience type, a restaurant location, and/or a dining (or seating) time (and/or date) when the meal should commence. In some embodiments, the selected restaurant 120A can also provide the user 130A a sample menu (shown in FIG. 13F) to enable the diner 130A to make an informed request.

Even further, advantageously, the concierge system 110 can enable the diner 130A to identify multiple restaurants 120A in the reservation request. In one embodiment, the diner 130A can identify an initial restaurant 120A for the reservation request and subsequently can add one or more additional restaurants 120A (shown in FIG. 13L). Additionally and/or alternatively, the diner 130A can identify the multiple restaurants 120A at the same time. The diner 130A thereby need not again specify the other request terms that are common to the reservation requests to be communicated to the restaurants 120A.

By enabling the diner 130A to identify multiple restaurants 120A, the concierge system 110 can communicate the same reservation request to each identified restaurant 120A, maximizing the likelihood that the reservation request will be fulfilled while minimizing the effort required of the diner 130A. If one of the multiple restaurants 120A accepts the reservation request, the concierge system 110 preferably inhibits any of the other multiple restaurants 120A from also accepting the reservation request. The concierge system 110 thereby can prevent more than one restaurant 120A from accepting the reservation request. In one embodiment, the concierge system 110 can block the other multiple restaurants 120A from viewing and/or accessing the reservation request.

In some embodiments, one or more of the reservation terms can be provided as a range. The meal price, for example, can be set forth as a range of meal prices. Additionally and/or alternatively, the requested dining time (and/or date) can include a selected range of dining dates and/or a selected range of dining times on the requested dining date. The concierge system 110 considers the reservation terms in initiating fulfillment of the reservation request in the manner discussed in more detail above with reference to FIG. 1.

Additionally and/or alternatively, the concierge system 110 can maintain a diner profile of the diner 130A and can consider the diner profile information in initiating fulfillment of the reservation request. Stated somewhat differently, the concierge system 110 can use the diner profile information to prequalify the diner 130A. Typical diner profile information can include information regarding one or more status, interests, behavior, preferences, and/or food allergies of the diner 130A. The concierge system 110 thereby can prequalify the diner 130A by assigning a diner status, such as preferred diner and/or new diner, to the diner 130A. In one embodiment, the concierge system 110 can maintain a diner profile of the diner 130A and, if the diner 130A is not prequalified, the restaurant 120A can consider the diner profile information of the diner 130A in determining whether to fulfill of the reservation request.

For example, the diner profile can include historical dining habits of the diner 130A. The dining habits can include information about food and beverage orders, an amount of money spent on a meal, an amount of time spent at a table, a favorite table at a restaurant, restaurant reviews (or feedback) by the diner 130A, and/or diner reviews by the restaurant from one or more past dining experiences by the diner 130A. In one embodiment, at least some of the diner profile information can be related to other diner profile information in the diner profile of the diner 130A. The diner status of the diner 130A, for instance, can be based at least in part on the diner reviews from the past dining experiences. The concierge system 110 can present the dining habits information for an individual dining experience and/or in the aggregate with, for example, statistical information, such as a minimum, maximum, average, and/or a standard deviation.

In one embodiment, the concierge system 110 can further enhance the dining experience by enabling the diner 130A to include specific dining details, such as identifying a desired table within a selected restaurant 120A, among the reservation terms. If the diner 130A requests an exceptional dining experience, such as a dining experience at an exclusive restaurant and/or at a higher demand time and/or date (or day), the concierge system 110 can present the diner 130A with an opportunity to offer a pricing premium to the restaurant 120A for the exceptional dining experience (shown in FIGS. 13G-H). The diner 130A can accept or decline to include the pricing premium offer in the reservation request, and/or the restaurant 120A can agree or refuse to accept diner offers to pay pricing premiums.

If the diner 130A and the restaurant 120A agree to engage in the pricing premiums, the pricing premium offer can be presented in any conventional manner and preferably comprises a bid on the premium dining experience. The bid can include any additional amount of money that the diner 130A is willing to pay the restaurant 120A to enjoy the exceptional dining experience. Although any accepted bid amount can be provided in its entirety to the restaurant 120A, the concierge system 110 and the restaurant 120A can share the accepted bid amount in a preferred embodiment. The accepted bid amount can be divided between the concierge system 110 and the restaurant 120A in any conventional manner. For example, the concierge system 110 can receive a predetermined amount (or percentage) of the accepted bid amount; whereas, the balance of the accepted bid amount is provided to the restaurant 120A.

In one embodiment, the bid can be presented as a predetermined percentage (and/or a predetermined percentage range) of the menu price of the meal. The predetermined percentage can include any percentage between zero percent (no premium) and one hundred percent (or more) of the menu price. The concierge system 110 can enable the diner 130A to present the predetermined percentage as a discrete percentage value and/or in preselected percentage increments. The preselected percentage increments can comprise any suitable uniform and/or different increments and, in one embodiment, can be ten percent increments.

To facilitate the bidding process, the concierge system 110 can compile statistics based upon historical bid rates and/or demand for the restaurant 120A. The restaurant 120A, for example, can provide the concierge system 110 with one or more conditions, such as higher demand times, dates, and/or days, during which reservation requests with diner bids are accepted. Additionally and/or alternatively, the concierge system 110 can gather diner demand data for the restaurant 120A and recommend one or more conditions under which the restaurant 120A could advantageously enable the diners 130A to include bids with the reservation requests. Based upon the condition information, the concierge system 110 can gather data regarding bid rates that the restaurant 120A previously accepted when the conditions were met. The accepted bid rates can be uniform and/or can differ based, for example, upon differences among the relevant conditions. The concierge system 110 thereby can compare the reservation terms of the reservation request of the diner 130A, determine whether the reservation request terms meet a selected condition, and, if so, suggest a bid rate to the diner 130A based upon the accepted bid rates when the selected condition is satisfied.

Although discussed in terms of pricing premiums for purposes of illustration only, the reservation request alternatively can include an offer to pay a reduced price for the dining experience. The reduced price offer may be appropriate, for example, if the requested dining experience is proposed for a less exclusive restaurant and/or at a time (and/or date) with lower demand. The diner 130A can present the reduced price offer to the restaurant 120A in the same manner in which the pricing premium offer is presented. In one embodiment, the concierge system 110 can make the bidding process available for all reservation requests. Additionally and/or alternatively, the bidding process can be made available only under predetermined conditions, such as for reservation requests for a meal during higher demand times, dates and/or days.

Additionally and/or alternatively, the restaurant inventory management system 100A can apply a predetermined pricing premium (or discount) to the menu price of the meal for all diners if at least one selected condition is met. In other words, the predetermined pricing premium (or discount) is applied to the menu price without instituting a bidding process. The predetermined pricing premium (or discount) can apply to a preselected group of diners 130A or uniformly to all diners 130A. The predetermined pricing premium (or discount) can comprise a predetermined dollar amount and/or a predetermined percentage of the menu price. Exemplary conditions under which the restaurant inventory management system 100A can apply the predetermined pricing premium (or discount) include the requested dining time being in a high demand time period, a selected menu item being scarce, and/or other market factors that can affect restaurant pricing.

In one embodiment, the predetermined pricing premium (or discount) comprises an adjustable pricing premium (or discount), wherein a first predetermined pricing premium (or discount) is applied when the condition is satisfied and a second predetermined pricing premium (or discount), being less than the first predetermined pricing premium (or discount), is applied when the condition is on the verge of being satisfied. Stated somewhat differently, the selected condition can comprise a first condition and a second condition that is related to the first condition. The first predetermined pricing premium (or discount) is applied when the first condition is satisfied, and the second predetermined pricing premium (or discount) is applied when the second condition is satisfied. For example, the first condition can be satisfied if the reservation request terms include a dining time during a time of high demand for a table; whereas, the second condition can be satisfied if the reservation request terms include a dining time during a time of medium demand.

If the selected condition includes a third condition that also is related to the first condition, a third predetermined pricing premium (or discount), being less than the first predetermined pricing premium (or discount), can be applied when the third condition is satisfied. In other words, the second and/or third conditions may be associated with opposite boundaries of the first condition. For example, the second condition can be satisfied if the reservation request terms include a dining time during an initial time of medium demand that precedes a period of high demand for a table, and the third condition can be satisfied if the reservation request terms include a dining time during a later time of medium demand that follows the period of high demand. The second predetermined pricing premium (or discount) can be greater than, less than, or equal to the third predetermined pricing premium (or discount).

If the reservation request identifies one or more selected restaurants 120A, for example, the concierge system 110 can communicate the reservation request to each selected restaurant 120A. Additionally and/or alternatively, the concierge system 110 can provide the diner 130A with at least one recommendation of a restaurant 120A suitable for fulfilling the reservation request and providing the requested dining experience. Each recommendation can be based at least in part of the reservation request and/or the diner profile information of the diner 130A. For example, the concierge system 110 can provide a customized recommendation by examining restaurant preferences of other diners with diner profiles and identifying those other diners with diner profiles that are similar to the diner profile of the diner 130A. In one embodiment, the concierge system 110 can provide a customized recommendation by examining diner profiles of other diners, identifying those other diners with diner profiles that are the same as (or similar to) the diner profile of the diner 130A, and presenting the restaurant preferences of the similar diners to the diner 130A. Stated somewhat differently, the reservation request can include one or more dining interests of the diner 130A, and the concierge system 110 can match the dining interests with the restaurant preferences of other diners with tastes that are similar to the tastes of the diner 130A. The concierge system 110 can permit the diner 130A to submit reservation requests to more than one restaurant 120A.

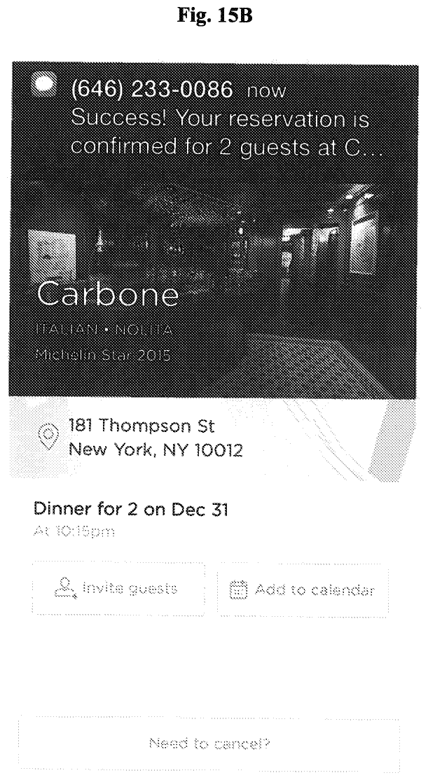

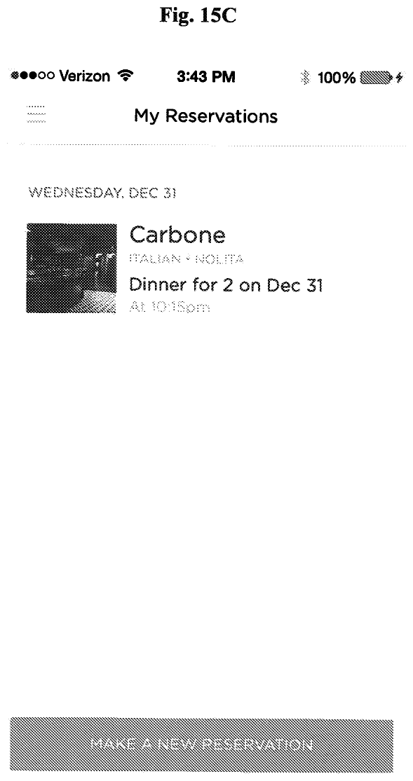

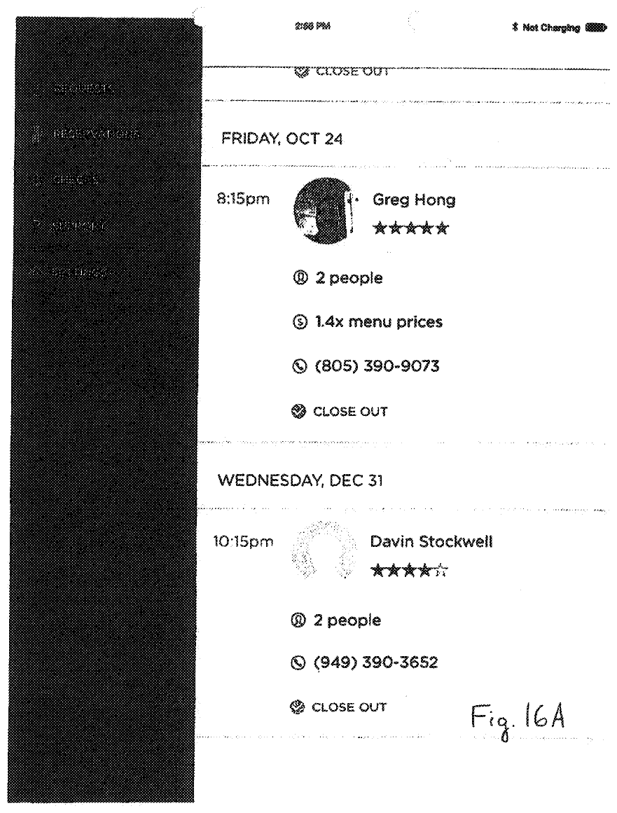

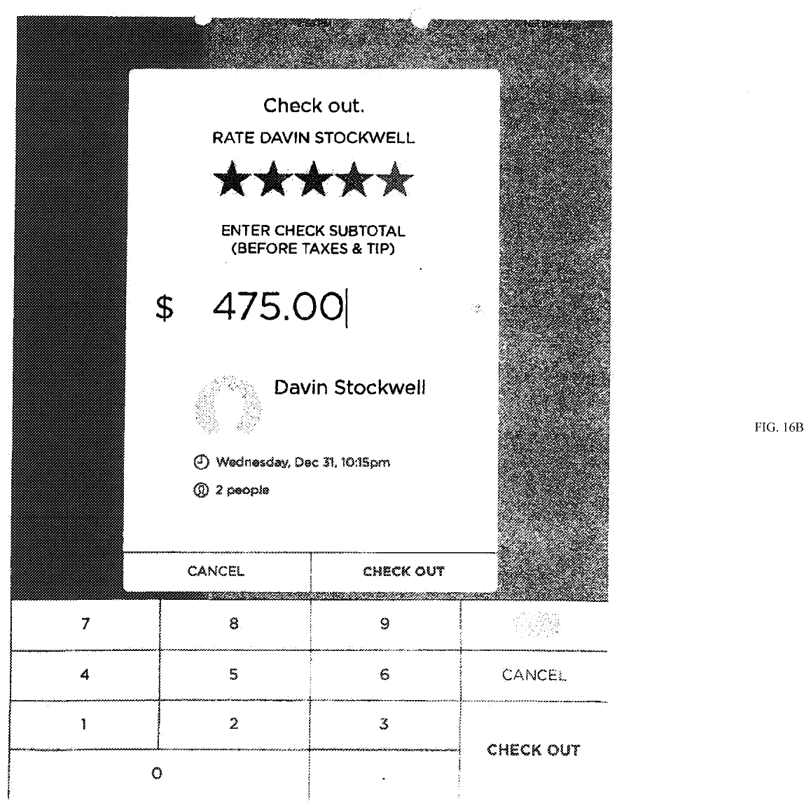

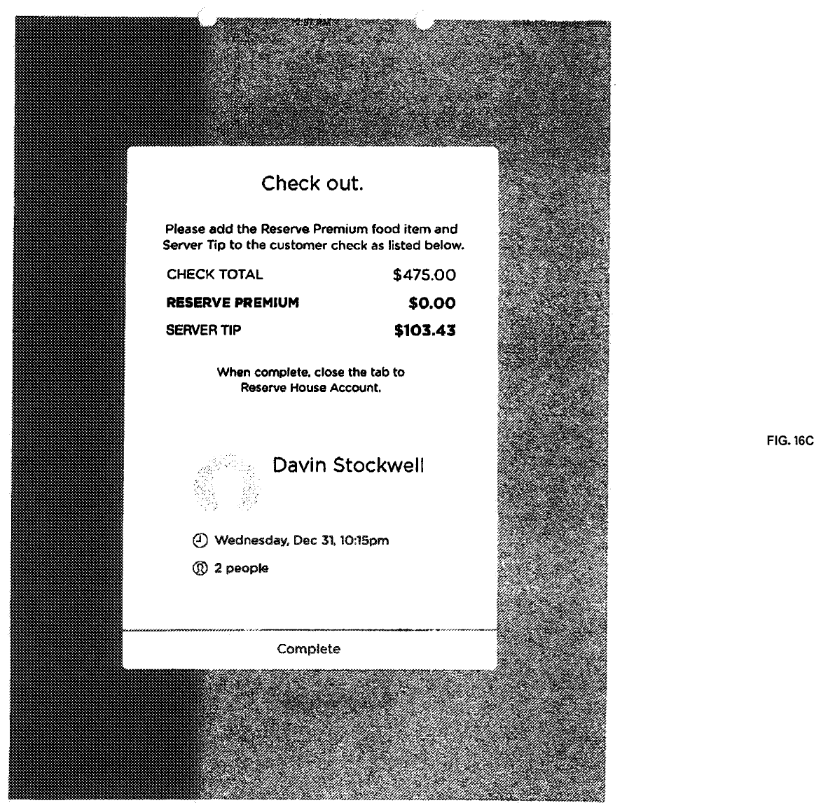

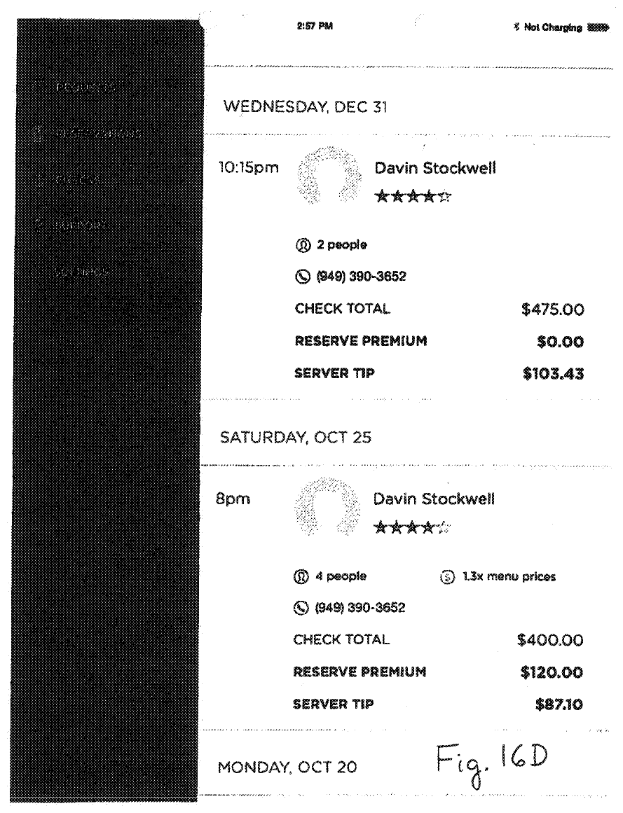

In some embodiments, the concierge system 110 enables the user 130A to review the reservation request before sending the reservation request to the selected restaurants 120A (shown in FIGS. 13I and 15A). The concierge system 110 preferably communicates the reservation request to the restaurant 120A in real time (or with as little time latency as is possible under the circumstances). The restaurant 120A can consider the reservation request and decide whether and, if so, how to accommodate the reservation request. In other words, the restaurant inventory management system 100A enables the restaurant 120A to employ a “demand-side” inventory management system for evaluating the reservation request. However, as discussed below, the inventory management system 100A can also provide a “supply-side” inventory management system and/or a combination of both.

In one embodiment, the reservation request can be accompanied by the diner profile information of the diner 130A. The availability of the diner profile information enables the restaurant 120A to determine whether and, if so, under what terms to accept the reservation request even if the diner 130A is a first-time diner at the restaurant 120A. The restaurant 120A, for example, can analyze the dining preferences and food allergies of the diner 130A to evaluate whether the menu offerings by the restaurant 120A are appropriate for the diner 130A. The prior restaurant reviews of the diner 130A likewise can be an indication of whether the restaurant 120A and the diner 130A would be a good match. If the concierge system 110 has prequalified the diner 130A, the restaurant 120A can base the decision of whether to fulfill the reservation request based at least in part on the diner status of the diner 130A. The restaurant 120A, for example, can automatically fulfill the reservation request if the diner 130A has a preferred diner status and a suitable table is available; whereas, if the diner 130A has a new diner status, the reservation request is not automatically fulfilled but, instead, undergoes the evaluation process by restaurant 120A.

Additionally and/or alternatively, the restaurant 120A can consider the dining habits, such as money and time spent on a meal, to intelligently optimize revenue and/or manage table inventory across one or more dining service turns when fulfilling the reservation request. In other words, the concierge system 110 enables the restaurant 120A to keep dining rooms full of diners 130A who may spend higher than average amounts on meals and to maximize a number of diners 130A who can be served during a selected time period. The diner status and/or table preference of the diner 130A can be assessed by the restaurant 120A when assigning the diner 130A to a particular table within the restaurant 120A. Advantageously, participation in the restaurant inventory management system 100A does not require the restaurant 120A to accept the reservation request and/or designate (or otherwise set aside) any tables for the benefit of the restaurant inventory management system 100A in advance of receiving the reservation request.

To enable the restaurant 120A to intelligently manage its table inventory, at least one term of the reservation request preferably is provided as a range of reservation terms. The dining time (and/or date), for example, can be provided as a range in the manner set forth above. Thereby, the restaurant 120A can determine table inventory status at each time (and/or date) within the range, enabling the restaurant 120A to select any time (and/or date) within the range for fulfilling the reservation request.

Advantageously, even if the restaurant 120A does not have sufficient table inventory to fulfill the reservation request at the time that the reservation request is received, the reservation request can be marked as reviewed and included on a “cancellation wait list” of the restaurant 120A. Thereby, if additional table inventory becomes available at a later time between receipt of the reservation request and a time (and/or date) within the range due, for example, to cancellation of a table reservation by another diner, the restaurant 120A can retrieve the pending reservation request from the cancellation wait list and accept the retrieved reservation request. The demand-side inventory system thus enables the restaurant 120A to subsequently accept the reservation request despite the earlier lack of table inventory. In other words, the demand-side inventory system of the inventory management system 100 can keep the reservation request pending, enabling the diner 130A to “stand in line” to have the reservation request accepted if table inventory later becomes available.

Upon determining that the reservation request cannot presently be accepted and will be added to a cancellation wait list or otherwise kept pending, the concierge system 110 can communicate the status of the pending reservation request to the diner 130A. The concierge system 110 likewise can inform the diner 130A of one or more options for proceeding with the pending reservation request. Exemplary options can include leaving the reservation request pending in case of a cancellation, adding one or more additional satisfactory restaurants 120A to the pending reservation request, and/or cancelling the pending reservation request entirely. By adding the additional restaurants 120A to the pending reservation request, the chances of the reservation request being accepted by one of the restaurants 120A increases. The concierge system 110 can remove the pending reservation request from the cancellation wait list of the initial restaurant 120A if another restaurant 120A accepts the pending reservation request or if the diner 130A cancels the pending reservation request.

Additionally and/or alternatively, the restaurant 120A can present a counteroffer to the reservation request. The counteroffer can be presented to the concierge system 110 and/or the diner 130A. In other words, the concierge system 110 can communicate the counteroffer to the diner 130A for consideration and/or can respond to the counteroffer on behalf of the diner 130A based upon the diner profile of the diner 130A. The diner 130A can accept or decline the counteroffer made by restaurant 120A. Continuing with the above example, if the restaurant 120A does not have sufficient inventory to fulfill the reservation request within the time (and/or date) range set forth in the reservation request, the restaurant 120A can present a counteroffer to fulfill the reservation request on a time (and/or date) outside of the range.

The restaurant 120A also can decline or accept the reservation request. If the restaurant 120A elects to decline the reservation request, the restaurant 120A can communicate a rejection to concierge system 110, which can inform the diner 130A of the rejection and/or provide at least one recommendation of an alternate restaurant 120A to the diner 130A in the manner set forth above. Alternatively, if the restaurant 120A elects to fulfill the reservation request, the restaurant 120A can communicate an acceptance to the concierge system 110 and enters (or moves) the accepted reservation request into a table management system of the restaurant 120A. The acceptance preferably includes a confirmed reservation time (and/or date) for fulfilling the reservation request. The concierge system 110 can inform the diner 130A (and any guests of the diner 130A) of the acceptance, including the confirmed reservation time (and/or date). The restaurant 120A can communicate the decision to accept or reject the reservation request to the concierge system 110 and/or the diner 130A as soon as the decision is made and preferably within a predetermined time period after receiving the reservation request (and with as little time latency as is possible under the circumstances). Additionally and/or alternatively, the diner 130A can view any pending and/or confirmed reservations at any time (shown in FIGS. 13M and 15C).

In one embodiment, the diner 130A can invite one or more guests to participate in the reservation request. The diner 130A, in other words, can offer to share the requested dining experience with the guests. The diner 130A can invite the guests at any time before the confirmed reservation time, including at the time when the diner 130A communicates the reservation request to the concierge system 110 and/or at the time when the diner 130A receives the reservation acceptance from the concierge system 110. The diner 130A preferably sends an invitation to each guest via the concierge system 110. For any invitations sent before the restaurant 120A accepts the reservation request, the concierge system 110 can inform the relevant guests of the acceptance, including the confirmed reservation time (and/or date), in the manner discussed above.

Advantageously, the concierge system 110 can provide the restaurant 120A with diner profile information for each invited guest who has a diner profile in the restaurant inventory management system 100A. Additionally and/or alternatively, the concierge system 110 can analyze the diner profile information of the diner 130A and the diner profile information of the guests to generate a collective profile and can provide the collective profile to the restaurant 120A. The restaurant 120A thereby can evaluate the diner profile information of the diner 130A and the guests individually and/or collectively when considering and/or fulfilling the reservation request in an effort to maximize the individual and/or collective dining experiences while optimizing table inventory utilization for the restaurant 120A.

The concierge system 110 can provide one or more reminders and/or confirmations about the accepted reservation request to the restaurant 120A and/or the diner 130A (and any guests of the diner 130A) in advance of the confirmed reservation time (and/or date) of the meal. Each confirmation can require a confirmation response from the diner 130A, advantageously alleviating the restaurant 120A of placing a conforming telephone call the diner 130A in advance of the meal. The restaurant 120A and/or the diner 130A can cancel the accepted reservation request at any time before the confirmed reservation time (and/or date). Although the cancelling party can communicate the cancellation to the other party directly, the cancelling party preferably communicates the cancellation to the concierge system 110, which informs the other party. The cancelled reservation request can be moved (or entered) into the table management system of the restaurant 120A.

In one embodiment, the reservation request can be subject to a cancellation policy. The cancellation policy can comprise a default cancellation policy of the restaurant inventory management system 100A and/or can be based upon a cancellation policy specific to the restaurant 120A. In one embodiment, the concierge system 110 can assess a cancellation fee to the diner 130A if the diner 130A fails to arrive at (or within a predetermined time period after) the confirmed reservation time and/or does not timely communicate the cancellation to the concierge system 110 and/or the restaurant 120A. The cancellation can be deemed to be untimely if communicated to the concierge system 110 and/or the restaurant 120A after a predetermined cancellation deadline. The predetermined cancellation deadline can be determined in any conventional manner and can be based on, for example, on a predetermined number of hours (or days), such as four hours, before the confirmed reservation time (and/or date). Additionally and/or alternatively, the cancellation can be deemed to be untimely if communicated to the concierge system 110 and/or the restaurant 120A after the concierge system 110 sends a selected reminder and/or confirmation.

At the confirmed reservation time (and/or date), the restaurant 120A begins to fulfill the reservation request. The diner 130A (and any guests of the diner 130A) thereby partakes of a meal at the restaurant 120A, which preferably identifies the diner 130A as participating in the restaurant inventory management system 100A. The manager and/or wait staff of the restaurant 120A thereby are notified of the arrival of the diner 130A and treat the diner 130A like a very important person (VIP) during the entire meal service. Advantageously, if the reservation request is accompanied by the diner profile information, the restaurant 120A can personalize the dining experience for the diner 130A (and any guests of the diner 130A). The restaurant 120A, for example, can address the diner 130A by name and/or customize the dining experience to the diner 130A based upon the provided diner profile information. In one embodiment, the restaurant 120A can alert the diner 130A of any menu items with ingredients related to a food allergy of the diner 130A, can advance order a bottle of a favorite wine of the diner 130A, and/or can surprise the diner 130A with a chef's bite, a favorite appetizer, or a special dessert.

The dining experience is consummated by the restaurant 120A tendering a summary and/or detailed check for the meal to the diner 130A. The check can be presented directly to the diner 130A and/or, in a preferred embodiment, the check preferably is tendered indirectly or electronically such as via electronic mail (or email) to a diner email address included in the diner profile of the diner 130A. In other words, the diner 130A need not be present to receive a physical check at the end of the dining experience. If the diner 130A is accompanied by any guests, the diner 130A and the guests can agree to split the check amount in any mutually-acceptable manner. The restaurant 120A therefore can prepare the split check in accordance with the mutually-acceptable manner and can tender the respective checks in the manner set forth above.

The check can include a price of the meal in an itemized and/or summary format. Additionally and/or alternatively, the check can include a tip for the wait staff, any taxes, and any surcharges, such as any pricing premium (or pricing reduction), any service fee, and any other charges, in accordance with the terms of the reservation request and/or the diner profile information for the diner 130A. In one embodiment, the diner profile for the diner 130A advantageously can include a standard (and/or default) tip rate; whereas, the concierge system 110 can determine relevant tax rate(s) for the meal based upon the location of the restaurant 120A. By applying the reservation terms of the reservation request and/or the diner profile information for the diner 130A, the concierge system 110 thereby can automatically generate the check without requiring interaction from either the restaurant 120A and/or the diner 130A.

To facilitate the electronic tendering of the check, the concierge system 110 can communicate with the POS system or other sale management software of the restaurant 120A. Although preferably integrated with the sale management software for automatic communications, the restaurant inventory management system 100A can include a restaurant interface, such as a provider computer system as discussed in more detail below, for enabling the restaurant 120A to process the transaction without being coupled with the sale management software. In one embodiment, the restaurant interface can enable the restaurant 120A to manually enter the price information from the POS system and can provide other transaction information, such as a tip amount, for manual entry into the POS system. The transaction thereby can be closed out to a house account (or tender) of the restaurant inventory management system 100A.

The diner profile information for the diner 130A preferably includes payment information. Exemplary payment information can include any conventional type of payment information, such as a credit card number, a debit card number, and/or a checking account number. In a preferred embodiment, the payment information enables payment to be processed via the ACH system. By using the ACH system, the diner 130A does not receive any credit card points for the transaction but can deem the overall experience provided by the restaurant inventory management system 100A to be more valuable than the credit card points. Further, use of the ACH system enables the restaurant 120A to increase revenue from the transaction by avoiding the credit card fees. Accordingly, the diner 130A and the restaurant 120A both receive a benefit from the restaurant inventory management system 100A.

As the requested dining experience nears completion, the concierge system 110 can submit a payment request on behalf of the restaurant 120A based upon the payment information of the diner 130A. In other words, the concierge system 110 can handle payment submission for the reservation such that the restaurant 120A and diner 130A are relieved from initiating the financial transaction and the related processing latencies.

The diner 130A, for example, can leave the restaurant 120A after the meal without a need to examine the check and/or to present payment information; whereas, a server is not required to make repeated trips between the table and a credit card terminal. The restaurant 120A advantageously can conclude the reservation request more efficiently and use the time savings to assist other diners; whereas, the diner 130A can engage in a subsequent activity without delay. The concierge system 110 likewise can record fulfillment information, such as an elapsed time, related to fulfillment of the reservation, and can provide the fulfillment information to the restaurant 120A. Accordingly, the restaurant inventory management system 100A can seamlessly manage the transaction for the dining experience from reservation request to payment in a manner that benefits both the restaurant 120A and the diner 130A. In a preferred embodiment, the restaurant inventory management system 100A can reopen the transaction if a transaction error subsequently is discovered.

Consummating the reservation request can include the diner 130A providing the concierge system 110 with review (or feedback) information about the restaurant 120A regarding the dining experience. In one embodiment, the diner 130A is required to review the restaurant 120A. If the diner 130A communicates with the concierge system 110 via a software application, for example, a rating screen can be presented when the diner 130A opens the software application after the dining transaction has been concluded. The rating screen can enable the diner to enter rating information regarding the concluded transaction. The software application preferably requires the diner 130A to complete the review by inhibiting the diner 130A from entering another reservation request or otherwise utilizing the software application until the review of the concluded transaction is completed.

The review can occur at any convenient time after the reservation request has been consummated and preferably before a predetermined amount of time elapses to help ensure that the diner 130A can provide an accurate review of the restaurant 120A. The review information from the diner 130A enables the concierge system 110 to receive feedback from the diner 130A who has actually dined at the restaurant 120A. The review information advantageously enables the concierge system 110 to confirm that the restaurant 120A continues to satisfy the predetermined minimum quality threshold established by the concierge system 110.

Accordingly, the restaurant inventory management system 100A can enable the diner 130A to provide a reservation request that describes a desired dining experience. The concierge system 110 can consider the reservation request in view of the preferences (and other diner profile information) of the diner 130A, the preferences (and other diner profile information) of any guests of the diner 130A, the preferences (and other diner profile information) of other diners who have preferences that are the same (or similar) to the preferences of the diner 130A (and any guests of the diner 130A), and/or the profiles of the prequalified restaurants 120A. Thereby, the concierge system 110 can provide the diner 130A with at least one recommendation of a restaurant 120A suitable for fulfilling the reservation request.

Once a selected restaurant 120A fulfills the reservation request, the concierge system 110 can compare the dining expectations of the diner 130A with the review (or feedback) information that the diner 130A provides about the restaurant 120A regarding the meal. As the diner 130A concludes additional transactions via the restaurant inventory management system 100A, the concierge system 110 can successively better restaurant recommendations and other services to the diner 130A and/or include more current, relevant, and actionable diner profile information to the restaurant 120A with a subsequent reservation request from the diner 130A. In an embodiment, the current, relevant, and actionable diner profile information of the diner 130A can be provided, in whole or in part, with a later reservation request from the diner 130A to another restaurant 120A. Further, the restaurant 120A can improve service to its diners based upon the review information.

Although the diner 130A can provide any feedback directly to the restaurant 120A, the concierge system 110 preferably provides the review information to the restaurant 120A without identifying the diner 130A and/or in an aggregate form combined with review information from other diners at the restaurant 120A. The diner 130A can provide review information related to selected attributes of the restaurant 120A, such as the meal taste and presentation, the ingredient quality, the menu options, the wait staff, and/or the dining atmosphere, which the concierge system 110 can use to evaluate the restaurant 120A and/or the restaurant 120A can use to improve dining service. If the diner 130A rates a selected restaurant attribute below a predetermined threshold, the concierge system 110 can require the diner 130A to provide actionable feedback with a detailed discussion of the basis for the low rating.

Additionally and/or alternatively, consummating the reservation request can include the restaurant 120A providing the concierge system 110 with review (or feedback) information about the diner 130A regarding the dining experience. The review information preferably includes information important to the restaurant 120A such as food and beverage ordered, an amount of money spent on the meal, an amount of time spent at the table, and/or a favorite table. In one embodiment, the restaurant 120A is required to review the diner 130A contemporaneously with the consummation of the reservation request. The restaurant 120A likewise can provide other diner information, such as diner preference information and other metadata, about the diner 130A at that time. The review information from the restaurant 120A enables the concierge system 110 to receive immediate feedback from the restaurant 120A who has actually completed a meal service for the diner 130A. The review information advantageously enables the concierge system 110 to update the diner profile of the diner 130A to include the review and/or other diner information. The concierge system 110 thereby can provide better dining recommendations to the diner 130A and/or include more current, relevant, and actionable diner profile information to the restaurant 120A with a subsequent reservation request from the diner 130A. In an embodiment, the current, relevant, and actionable diner profile information of the diner 130A can be provided, in whole or in part, with a later reservation request from the diner 130A to another restaurant 120A. The concierge system 110 preferably does not share the review information from the restaurant 120A with the diner 130A.

The concierge system 110 can assess a concierge fee for matching the reservation request of the diner 130A with the available table inventory of the restaurant 120A. Although the concierge fee preferably is assessed only to the diner 130A, the concierge system 110 can assess at least part of the concierge fee to the restaurant 120A. Additionally and/or alternatively, the concierge system 110 can share the concierge fee with the restaurant 120A. An amount of the concierge fee can be determined in any conventional manner. The concierge fee amount, for example, can comprise a flat fee and/or can be based at least in part on one or more amounts that appear on the check for the meal. The concierge system 110 can reduce and/or waive the concierge fee. The concierge fee, for instance, can be reduced and/or waived if the diner 130A uses predetermined payment information for settling the meal check. The predetermined payment information can include a credit card number, a debit card number, and/or a checking account number and preferably enables payment to be processed via the ACH system.

In one embodiment, the inventory management system 100 (or restaurant inventory management system 100A) can include one or more computer program products, such as a software application. Stated somewhat differently, an inventory management method by which the inventory management system 100 administers matches between user requests (or diner reservation requests) and provider inventory (or restaurant tables) can be incorporated into the computer program products. Each computer program product can include a sequence of instructions encoded on a non-transitory, tangible machine-readable storage medium and/or suitable for execution by a conventional computer (or server) system, such as a desktop computer, a laptop computer, or a workstation, without limitation. Preferably, at least one computer program product is provided as a mobile app for a smartphone, a tablet computer and/or any other conventional mobile device.

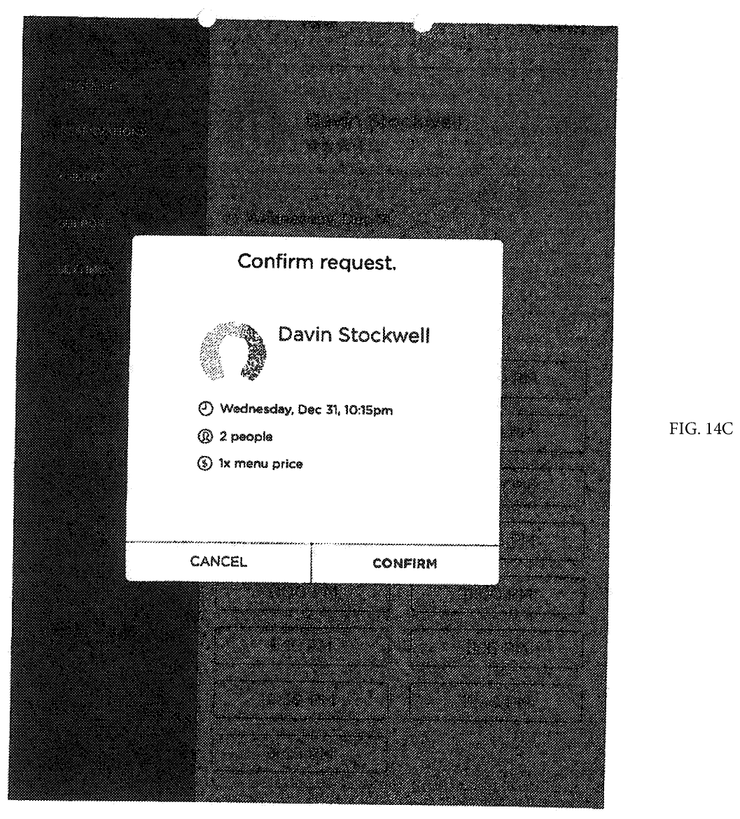

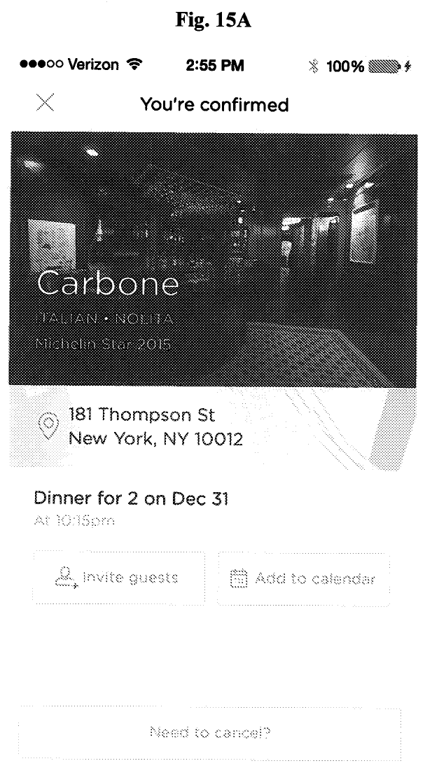

In one embodiment, the inventory management system 100 includes a concierge computer program product that is associated with the concierge system 110 (such as shown in FIGS. 14A-C and 16A-D). The concierge computer program product can be installed in a concierge computer system, which preferably comprises a server system for hosting the inventory management system 100, and includes one or more instructions for performing at least one function attributed to the concierge system 110 discussed above with reference to FIGS. 1 and 12.

Additionally and/or alternatively, the inventory management system 100 can include a user computer program product that is associated with the user 130 (or diner 130A). The user computer program product includes one or more instructions for performing at least one function attributed to the user 130 as discussed above with reference to FIGS. 1 and 12 and can be separate from, or at least partially integrated with, the concierge computer program product. The user computer program product can be installed in a user computer system disposed at a location associated with the user 130. Although the user computer system can comprise any conventional type of computer system, the user computer system preferably comprises a mobile device, such as a smartphone, because the user 130 can be ambulatory and thus can readily change locations. Although each user 130 preferably is associated with a respective user computer system, two or more users 130 can share a selected user computer system and/or a selected user 130 can be associated with more than one user computer system.

Additionally and/or alternatively, the inventory management system 100 can include a provider computer program product that is associated with the provider 120 (or restaurant 120A). The provider computer program product includes one or more instructions for performing at least one function attributed to the provider 120 as discussed above with reference to FIGS. 1 and 12 and can be separate from, or at least partially integrated with, the concierge computer program product and/or the user computer program product. The provider computer program product can be installed in a provider computer system disposed at a place of business of the provider 120. The provider computer system can comprise any conventional type of computer system and can be a mobile device, such as a smartphone, tablet computer, or laptop computer. Although each provider 120 preferably is associated with a respective provider computer system, two or more providers 120 can share a selected provider computer system and/or a selected provider 120 can be associated with more than one provider computer system. If the selected provider 120 operates multiple establishments in different geographical locations, for example, each establishment can be associated with a respective provider computer system and/or share aspects of the provider computer system, such as user information across all providers 120.

The concierge computer system can communicate with each provider computer system and/or each user computer systems in any conventional manner, including via computer network communications. In some embodiments, the communication can be based on cloud-computing systems. Typically being disposed remotely from the concierge computer system, the provider computer system(s) and/or the user computer system(s) preferably communicate with the concierge computer system via a wide area network such as the World Wide Web (or Internet).

Advantageously, the concierge computer program product, the user computer program product and/or the provider computer program product can cooperate with one or more conventional computer applications. Exemplary conventional computer applications can include a calendar application, an electronic mail (or email) application, an Internet browser application, a texting application, a reminder application, a clock application, and/or a contacts application without limitation. The concierge computer program product, the user computer program product and/or the provider computer program product thereby can readily integrate with the concierge computer system, the user computer system, and/or the provider computer system, respectively.

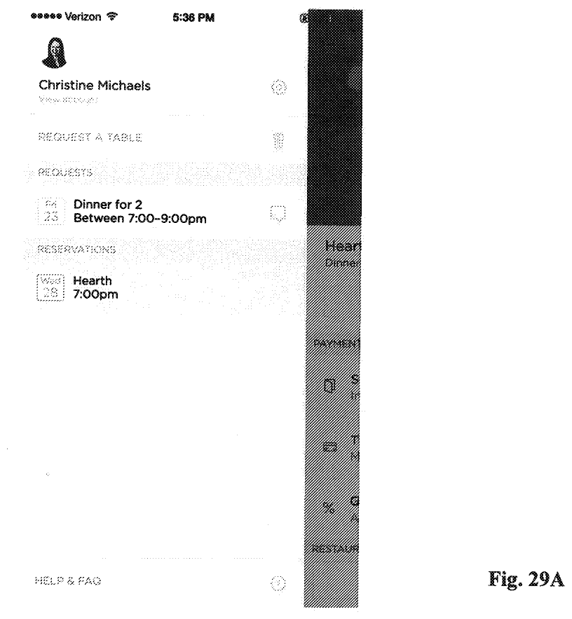

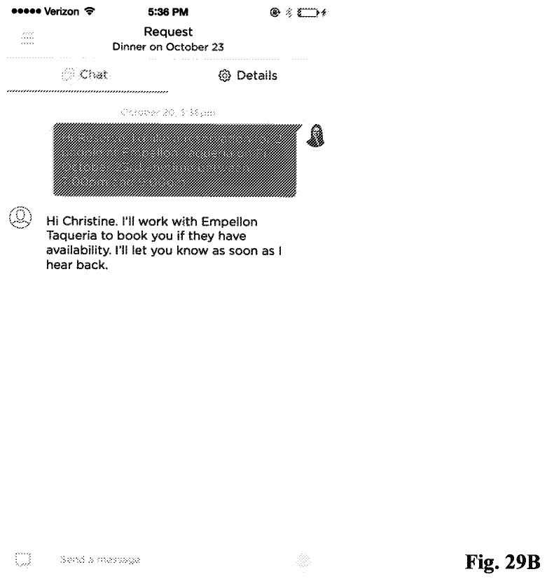

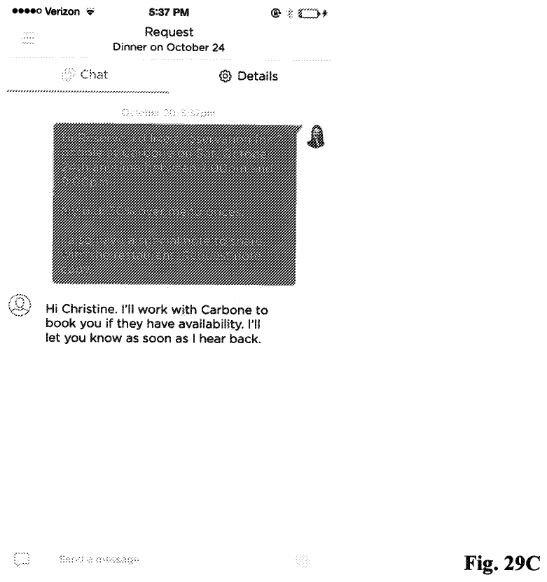

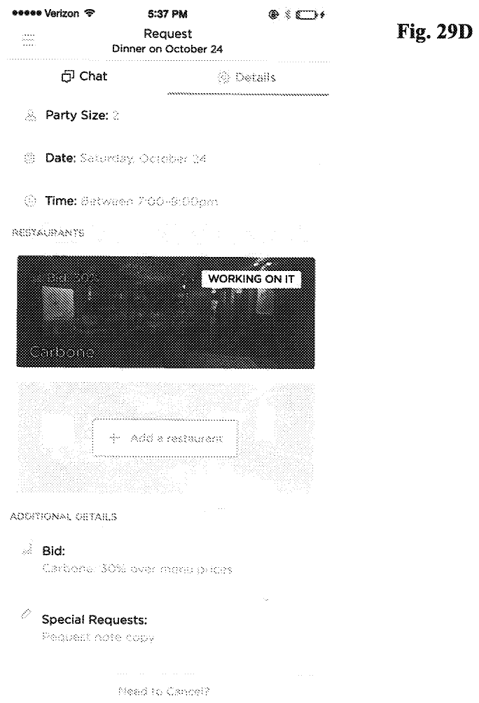

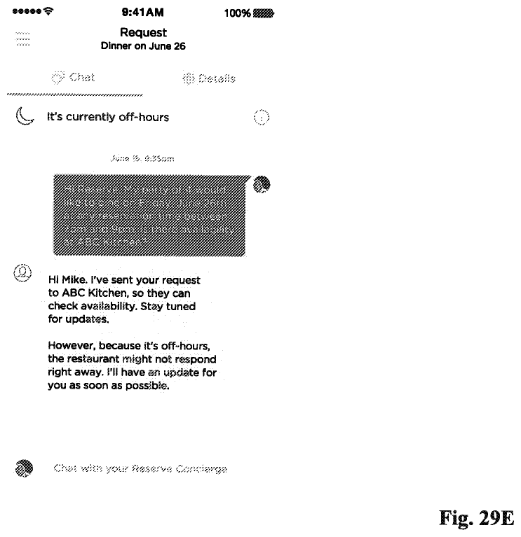

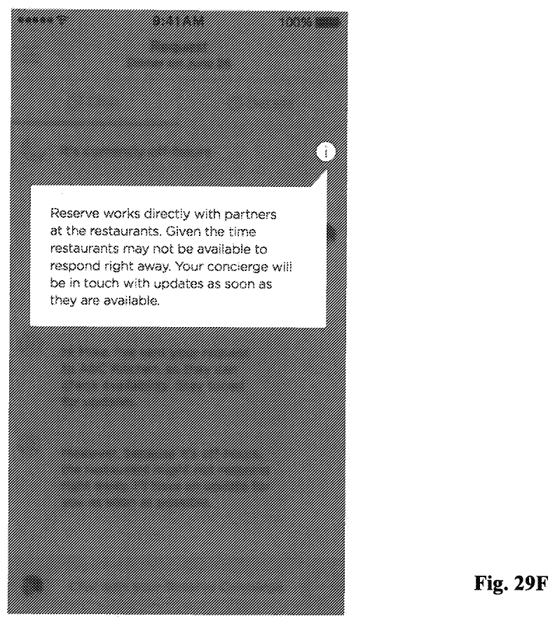

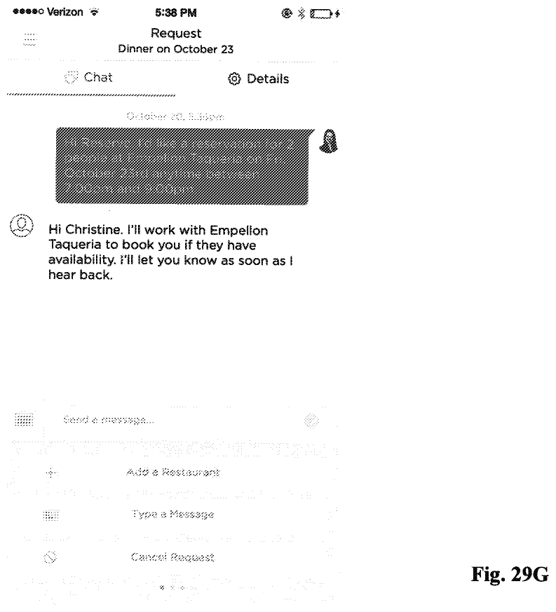

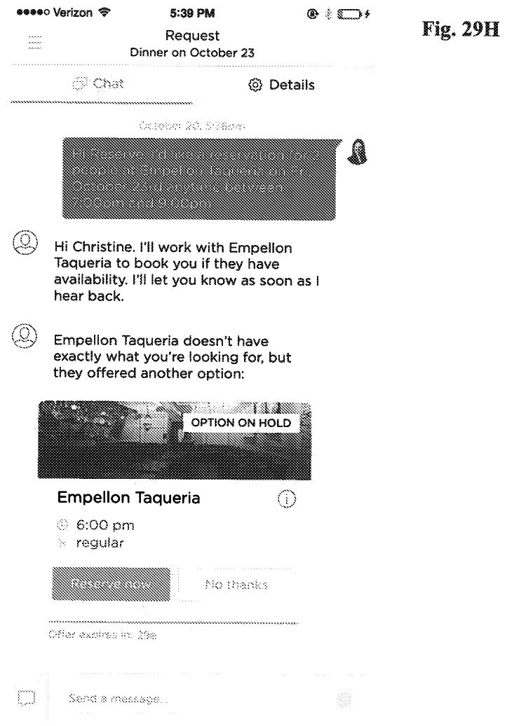

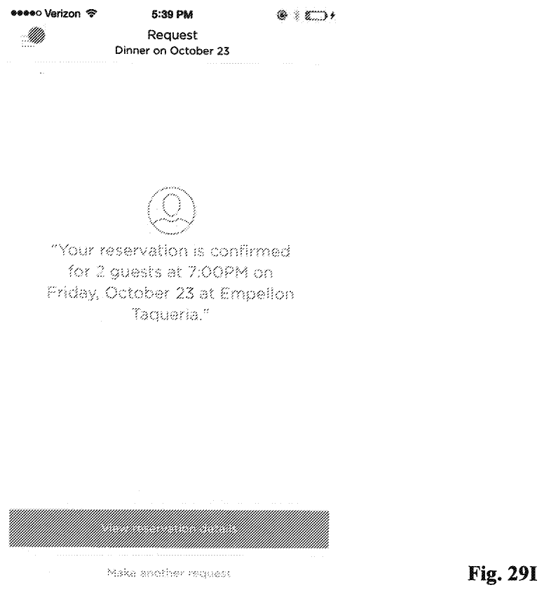

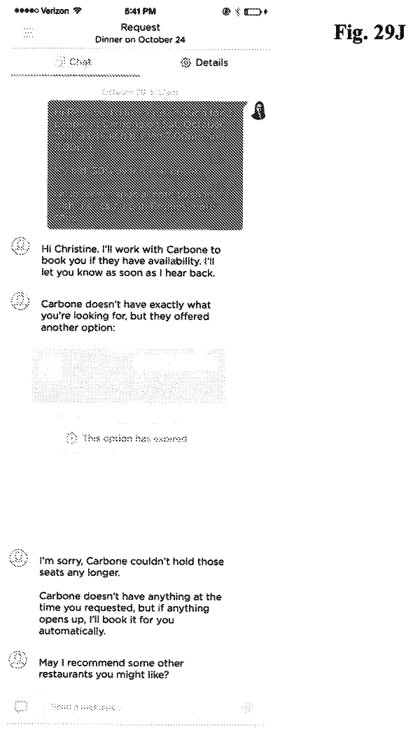

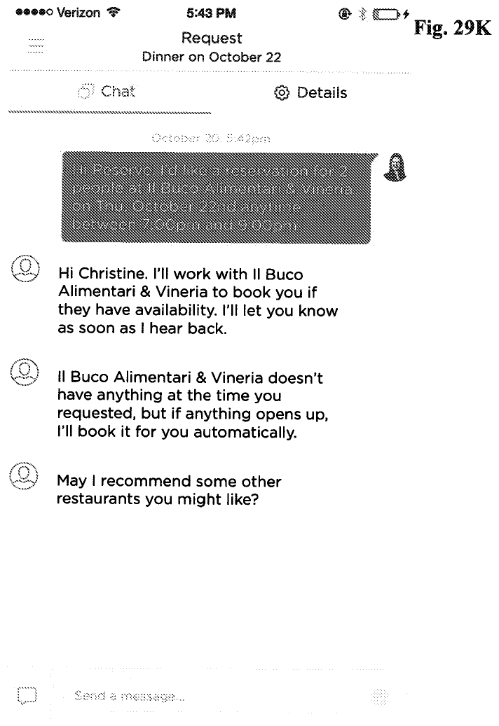

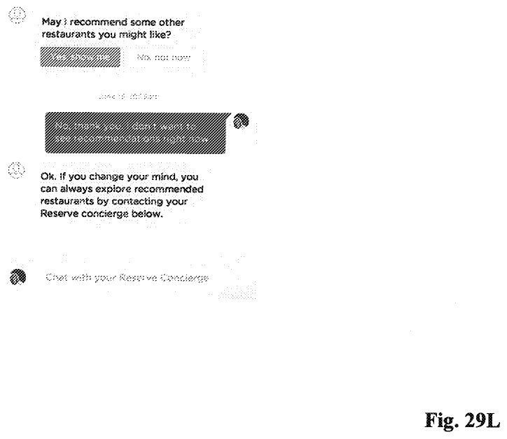

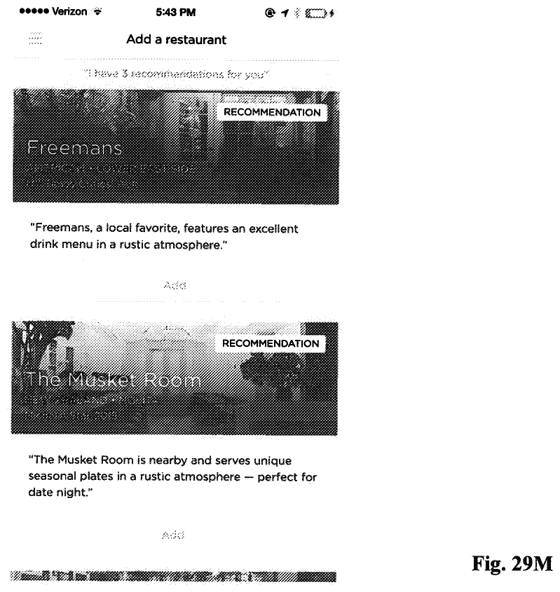

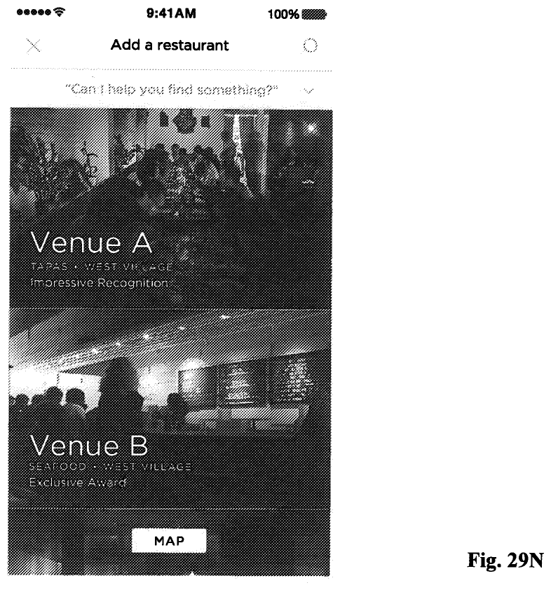

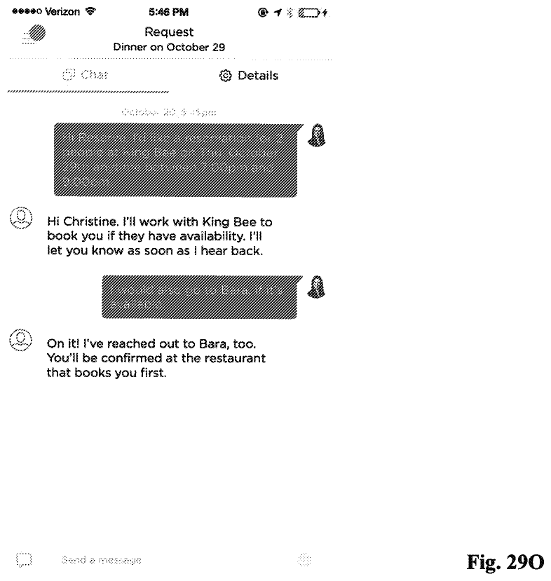

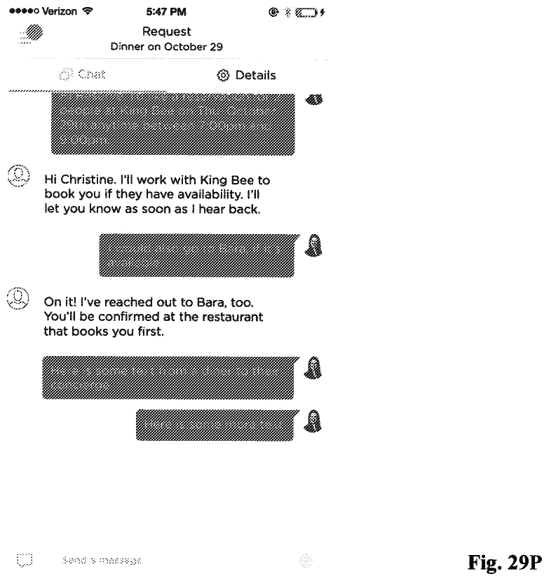

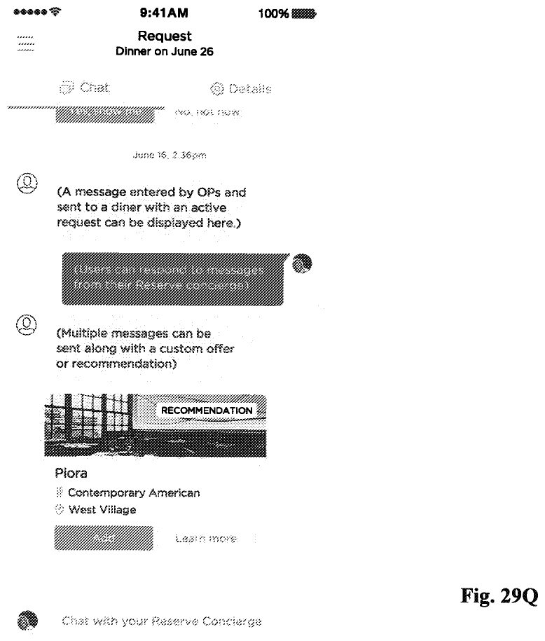

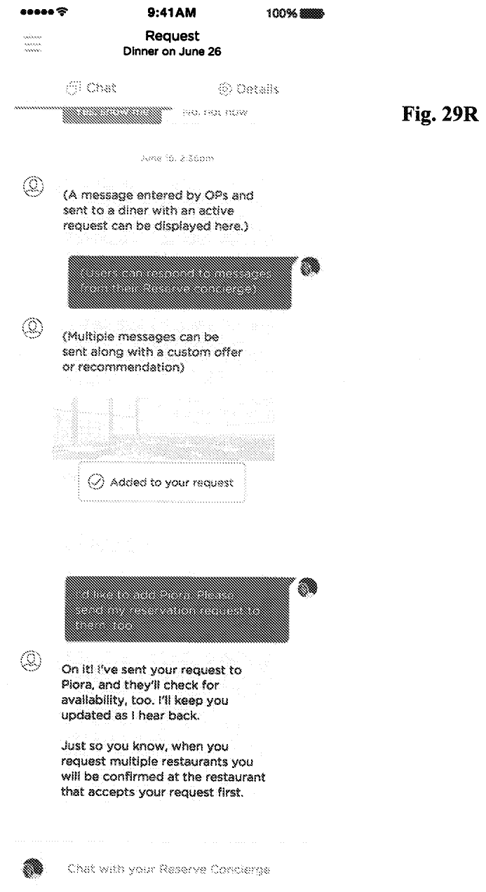

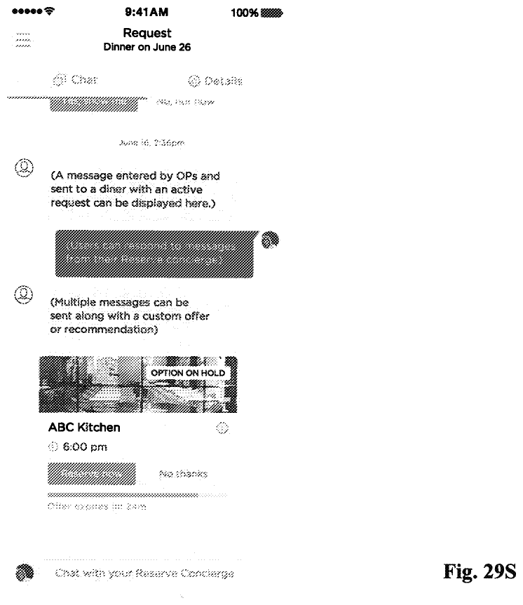

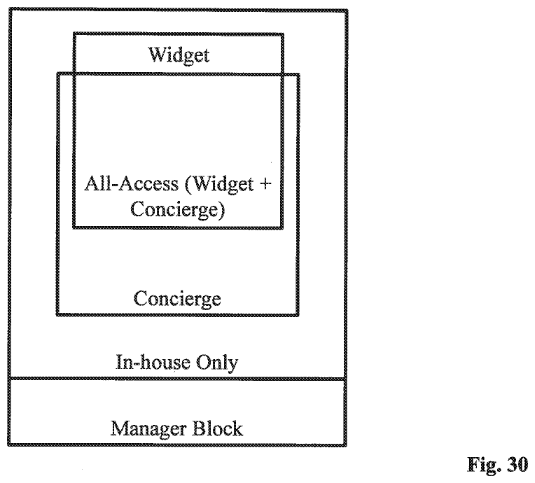

With reference to the user computer system, for example, the communications between the user computer system and the concierge computer system and/or the provider computer system can be conducted in any conventional manner, including via text message and/or electronic mail, and/or via other types of notifications, such as badges, alerts, sounds and/or banners. In a particular example, the user computer system can provide a user interface similar to a conventional text message screen (such as shown in FIGS. 29A-S). For example, in FIG. 29A, the user can see a count of new messages that they have not read from the provider computer system in a Conversation view. Additionally and/or alternatively, the methods discussed above with reference to FIGS. 1-12 can be implemented via the Conversation view shown in FIG. 29A. Turning now to FIG. 29B, a sample user request can be made using a Conversation view chat. As shown, the provider 120 advantageously responds to the user in real-time to provide visual confirmation of the request. The Conversation view allows for flexibility in the request, such as providing special requests, as shown in FIG. 29C.

The user computer system thereby can receive confirmations and/or updates about the request from the concierge computer system and include information about the request in a calendar application of the user computer system. The user computer system can automatically present reminders about the request at predetermined times. Additionally and/or alternatively, the user computer system can enable the user 130 to access a contacts application of the user computer system to send one or more guest invitations after the request has been accepted by the provider 120. In other words, the guest invitations can be sent to the guests conducted in any conventional manner, including via text message and/or electronic mail. Advantageously, the guest invitations thereby are sent in a manner that identifies the user 130 as the sender, rather than the concierge system 110 and/or the provider 120 who may be unknown to the guests.

With reference to the provider computer system, for example, any communications between the provider computer system and the concierge computer system and/or the user computer system can be conducted in any conventional manner, including via text message and/or electronic mail, and/or via other types of notifications, such as badges, alerts, sounds and/or banners. The provider computer system thereby can receive cancellations and/or updates about the request from the concierge computer system and can include information about the request in a calendar application or table management application of the provider computer system. The provider computer system can automatically present reminders to the user 130 and/or to the provider 130 about the request at predetermined times.

In one embodiment, the provider computer system can present user profile information of the user 130. Exemplary user profile information can include a name, photograph and/or contact information for the user 130. The user profile information of the user 130 preferably is presented at (and/or a predetermined time before) the requested delivery time. The provider 120 thereby can recognize the user 130 upon arrival and can greet the user 130 by name, personalizing the transaction experience. By providing contact information for the user 130 at the predetermined time before the requested delivery time, the provider 120 can contact the user 130, if desired, to confirm the request.

Advantageously, the provider computer system can communicate with, and/or can be at least partially integrated with, the point of sale (POS) system or other sales management software of the provider 120. In one embodiment, the provider computer system can be disposed adjacent to the POS system. The provider 120 thereby can enter information regarding the requested products and/or services into the POS system, which can provide the information to the provider computer system. The POS system preferably includes a button or other control for identifying that the request for products and/or services has been entered via the inventory management system 100. Activation of the control can initiate communication between the POS system and the provider computer system with regard to the request. Once the communication is initiated, the provider computer system can process the request in the manner set forth above with reference to FIGS. 1 and 12.

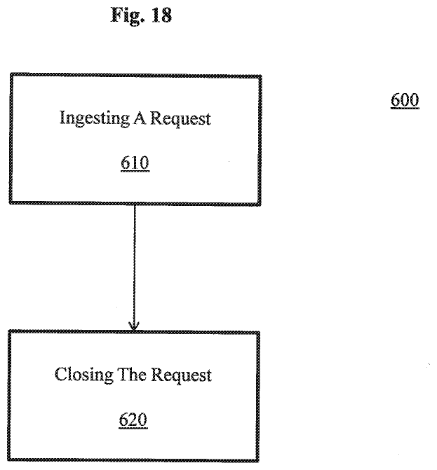

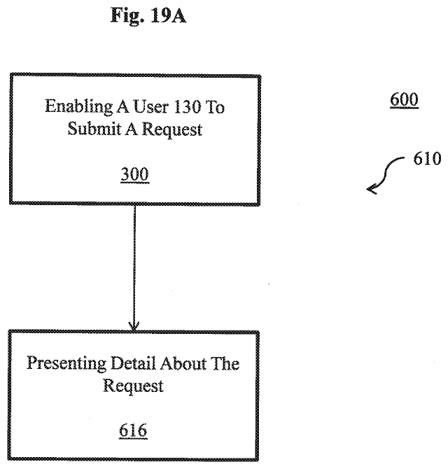

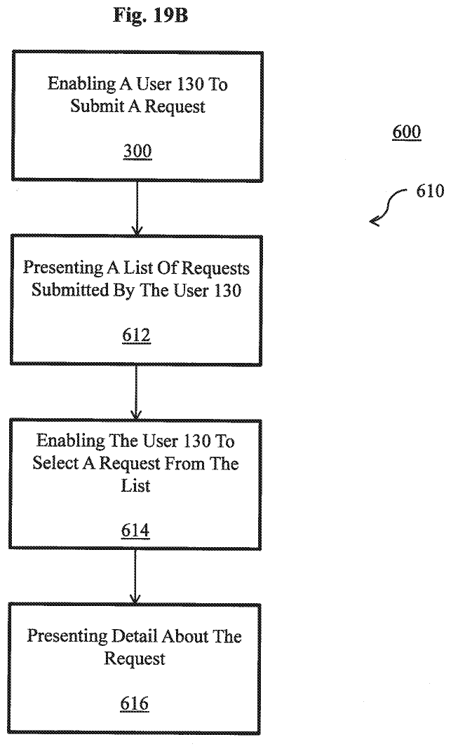

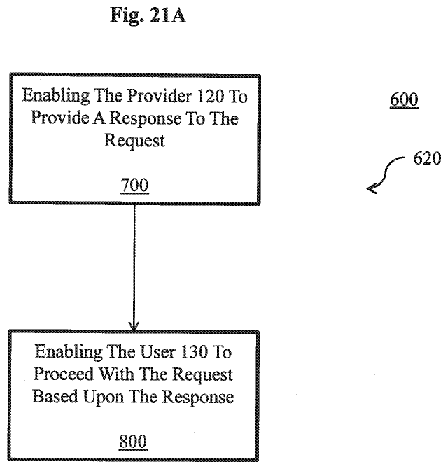

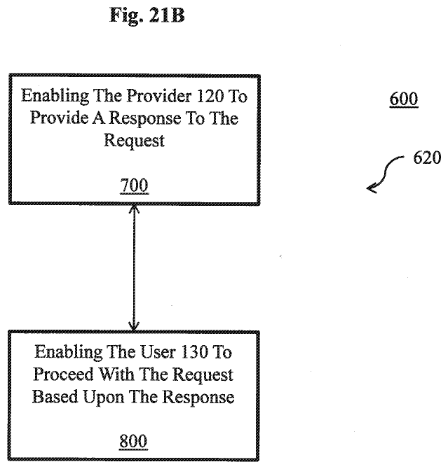

FIG. 18 illustrates an alternative concierge method 600 for matching user requests with provider inventory. As shown in FIG. 18, the concierge method 600 includes ingesting a request, at 610. The request can be provided by a user 130 (shown in FIGS. 19A-B) in the manner discussed in more detail above with reference to FIGS. 1-12 and can be compared with available provider inventory of a provider 120 (shown in FIGS. 21A-B). Once compared with the available provider inventory, the provider 120 can provide with user 130 with a response to the offer. For example, the response can include a confirmation of a booking when all parameters of the request are met and/or suggestions for alternative reservations. The user is enabled to proceed with the request based upon the response of the provider, ultimately leading to closing the request, at 620. The request can be closed, at 620, in any conventional manner, including, for example, by the request being accepted (or otherwise confirmed) and/or canceled by the provider and/or the user 130.

Turning to FIG. 19A, one embodiment of ingesting a request, at 610, is shown. The illustrated concierge method 600 includes enabling a user 130 to submit a request, at 300. The user 130 can submit the request in any suitable manner, including in the manner by which the request was submitted, at 300, as set forth above with reference to FIG. 3. Detail about the request can be presented to the user 130, at 616. The presented detail can include type of information that relates to the request.

An alternative embodiment of ingesting a request, at 610, is illustrated in FIG. 19B. Turning to FIG. 19B, a list of requests submitted by the user 130 can be presented, at 612. The list of requests preferably is limited to requests of the user 130 that have not been closed, the requests that have not been closed, or open requests. Exemplary open requests can include a request submitted by the user 120 but not yet evaluated by the provider 130, a request on the wait list of the provider 120 and/or a pending request that has been accepted by the provider 120 and that is pending action by the user 130, without limitation.

Whereas a first time user 130 might be directed to the presented detail, at 616, upon entering a first request, a returning user 130 with several requests, can be presented with the list of requests, at 616. The user 130 thereby can view each request. Advantageously, the concierge method 600 can permit the user 130 to manage the requests by, for example, enabling the user to select a request from the list, at 614. The user 130 can manage the requests by, for example, deleting one or more requests, such as requests that the user 130 wishes to cancel, and/or can viewing detail about the request, at 616, in the manner discussed above.

Turning to FIG. 20A, additionally and/or alternatively, the concierge method 600 can present a suggestion to the user 130, at 618A. The suggestion can include an alternative offer for fulfilling the request and/or a recommendation for additional (and/or alternative) requests. Stated somewhat differently, the suggestion can be related to the request and/or unrelated to the request. The alternative offer and/or recommendation preferably is based upon the preferences (and other user profile information) of the user 130, the preferences (and other user profile information) of any guests of the user 130, the preferences (and other user profile information) of other users who have preferences that are the same (or similar) to the preferences of the user 130 (and any guests of the user 130), and/or the profiles of the prequalified providers 120 as discussed above. The user 130 is enabled to accept the suggestion, at 618B, and can accept or decline the suggestion, at 618C.

The suggestion likewise can include suggestion terms, such as, terms for setting forth acceptance criteria for the suggestion. For example, the suggestion can expire if the user does not accept the suggestion within a predetermined period of time after the suggestion is presented. In other words, the suggestion can be deemed declined either by the user 130 affirmatively declining the suggestion, at 618C, or automatically if the user 130 does not timely respond to the suggestion. The suggestion, if accepted, can be included with the request on the list, at 618D, and the detail of the request can again be presented to the user 130, at 616.

The concierge method 600 can present more than one suggestion to the user 130. Multiple suggestions can be simultaneously and/or serially presented to the user 130. As illustrated in FIG. 20B, for example, another suggestion can be presented to the user 130, at 618E, once the user 130 has acted on the original suggestion (and/or the original suggestion has expired on its own suggestion terms). The suggestions preferably are presented in a conversational manner, such as a conversation between the user 130 and a concierge.

Once the request has been ingested, at 610, the concierge method 600 proceeds with closing the request, at 620, as set forth above with reference to FIG. 18. The request can be closed in any suitable manner. An exemplary manner for closing the request is illustrated in FIG. 21A. As shown in FIG. 21A, closing the request, at 620, can include enabling the provider 120 to provide a response to the request, at 700, and enabling the user 130 to proceed with the request based upon the response provided by the provider 120, at 800. FIG. 21B illustrates that closing the request, at 620, can involve several iterations of communications between the user 130 and the provider 120 with each responding to proposals by the other. These communications preferably are presented in a conversational manner, such as a conversation between the user 130 and the provider 120.

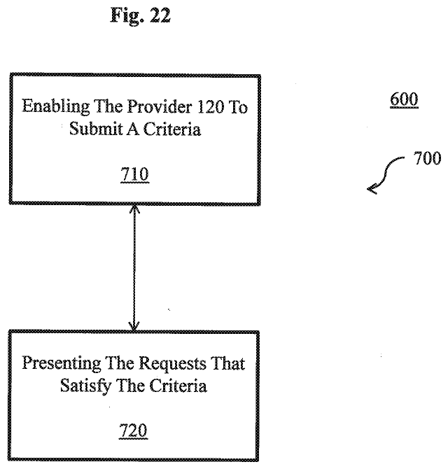

FIG. 22 shows that enabling the provider 120 to provide the response to the request, at 700, can include enabling the provider 120 to submit one or more criteria, at 710, for presenting at least one request that satisfies the criteria. Exemplary criteria can include a date upon which a request was received, a date upon which a request is to be fulfilled, a request status and/or any other characteristic of the requests submitted to the provider 120. The requests that satisfy the criteria can be presented, at 720, to the provider 120. In one preferred embodiment, the presented requests can include a list of open requests with a selected fulfillment data, wherein the requests are grouped by request status: new requests; requests on the wait list; and accepted requests pending action by the user 130.

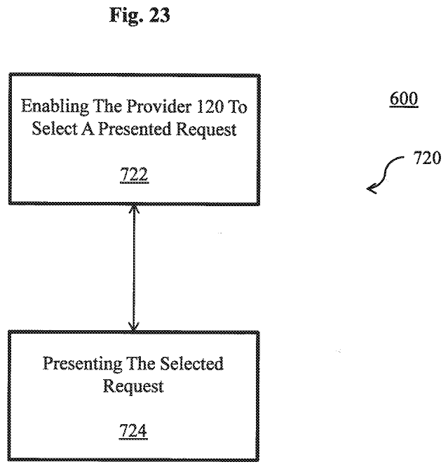

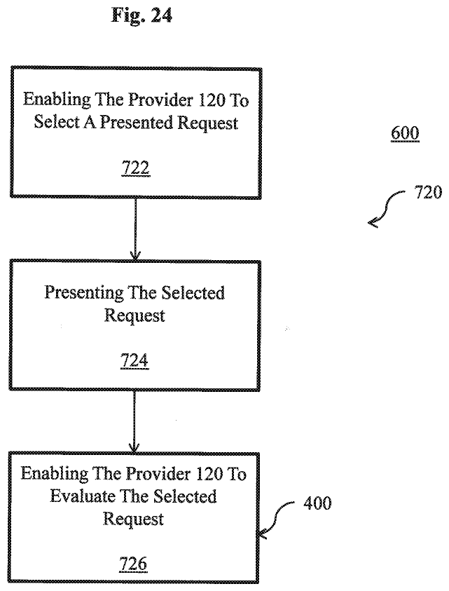

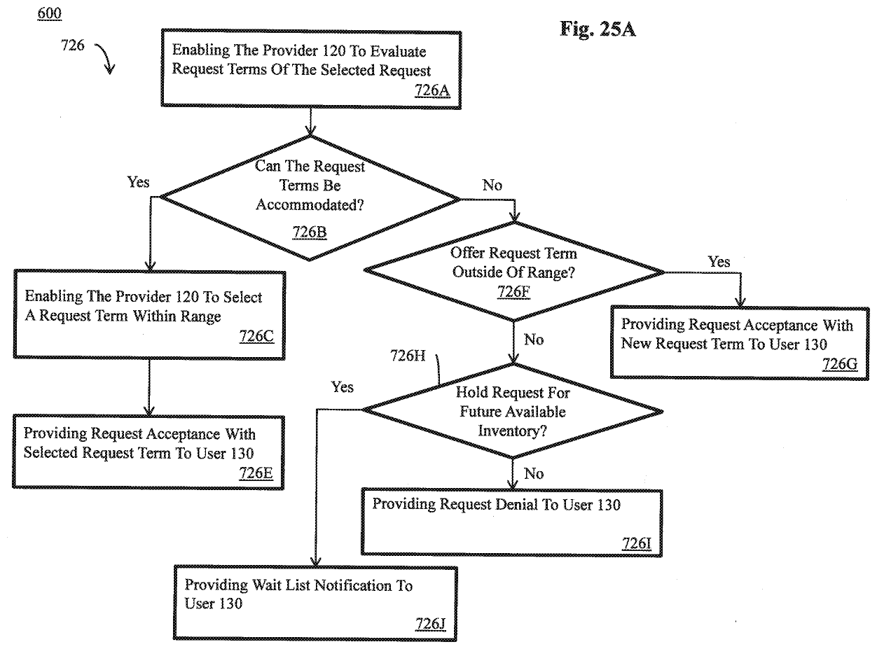

Once the requests that satisfy the criteria are presented, at 720, the provider 120 can be enabled to select at least one presented request, at 722, as illustrated in FIG. 23. The selected request can be presented, at 724, to the provider 120. FIG. 24 shows that the provider 120 can be enabled to evaluate the selected request, at 400. The provider 120 can evaluate the selected request in any suitable manner, including in the manner discussed in more detail above, for example, with reference to FIGS. 5 and 6. The provider 120 preferably evaluates the selected request in an effort to determine a disposition for the selected request.

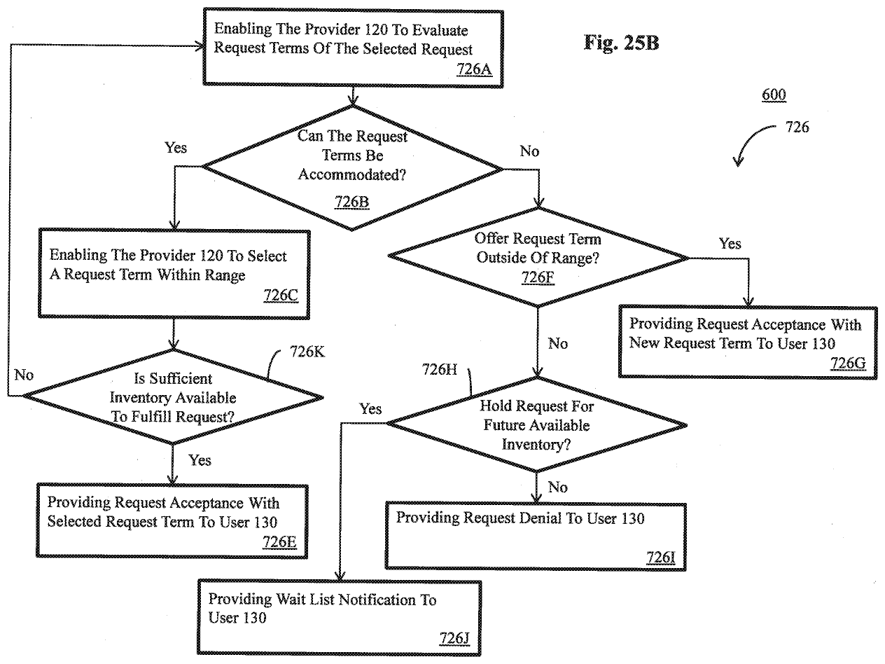

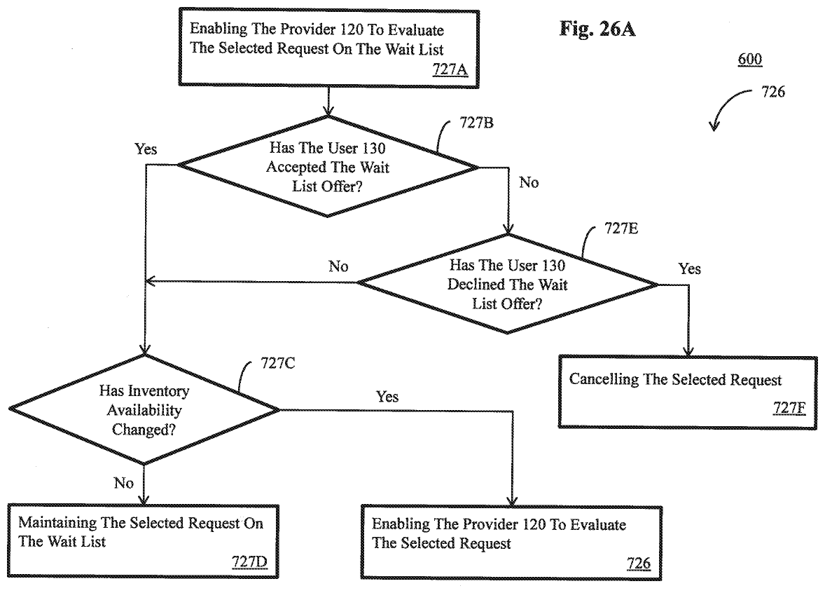

FIG. 25A illustrates an exemplary manner by which the provider 120 can evaluate the selected request when the selected request comprises a new request that is awaiting initial review. In other words, the request has been recently submitted by the user 130 or otherwise has not been previously evaluated by the provider 120. Turning to FIG. 25A, the provider 120 can be enabled to evaluate the request terms of the selected request, at 726A. As discussed above with reference to FIG. 1, the selected request can include one or more request terms, wherein exemplary request terms can include conventional contract terms such as a requested product and/or service, a requested provider 120, a requested price, a requested delivery location, and/or a requested delivery time (and/or date). The provider 120 can consider the request terms in initiating fulfillment of the selected request.

The inventory management system and method can, for example, enable the provider 120 to compare the request terms of the selected request with available inventory to determine whether the selected request can be accommodated, at 726B. Advantageously, the inventory management system and method optionally can alert the provider 120 of any request on the wait list of the provider 120 that conflicts with the new request. Stated somewhat differently, one or more of the request terms of the new request can conflict with one or more of the request terms of the request on the wait list. The new request and the request on the wait list, for example, can include the same requested delivery time (and/or date). By alerting the provider 120 of the conflict between the new request and the request on the wait list, the inventory management system and method can help prevent the provider 120 from accepting the new request with request terms that conflict with the request terms of the request on the wait list.

If the selected request can be accommodated with the available inventory, the provider 120 can provide an acceptance of the selected request. In the manner set forth above with reference to FIG. 1, one or more of the request terms can be provided as a predetermined range. For such request terms, the provider 120 can specify a request term, at 726C, that is within the predetermined range for the selected request. The request acceptance with the specified request term can be provided to the user 130, at 726E.

As desired, the request acceptance with the specified request term can be compared, at 726K, with the available inventory before the request acceptance is provided to the user 130 as shown in FIG. 25B. If insufficient available inventory exists, the provider 120 again can be enabled to evaluate the request terms of the selected request in the manner discussed above. As shown in FIG. 25A, if the selected request cannot be accommodated with the available inventory, the provider can suggest a different request that can be accepted with one or more new and/or different request terms. The provider 120, for example, can consider the available inventory and try to identify options for accommodating the request.

The accommodation of the request, for example, can include terms that are different from the request terms. For instance, the provider 120 can specify a request term, at 726F, that is outside of the predetermined range for the selected request. In a restaurant environment, the new and/or different request term can include a table that is different from a requested table and/or a dining time that is different from a requested dining time. The different dining time, for example, can comprise “shoulder time,” a period between meal services, in an effort to accommodate a diner 130A (shown in FIG. 12).

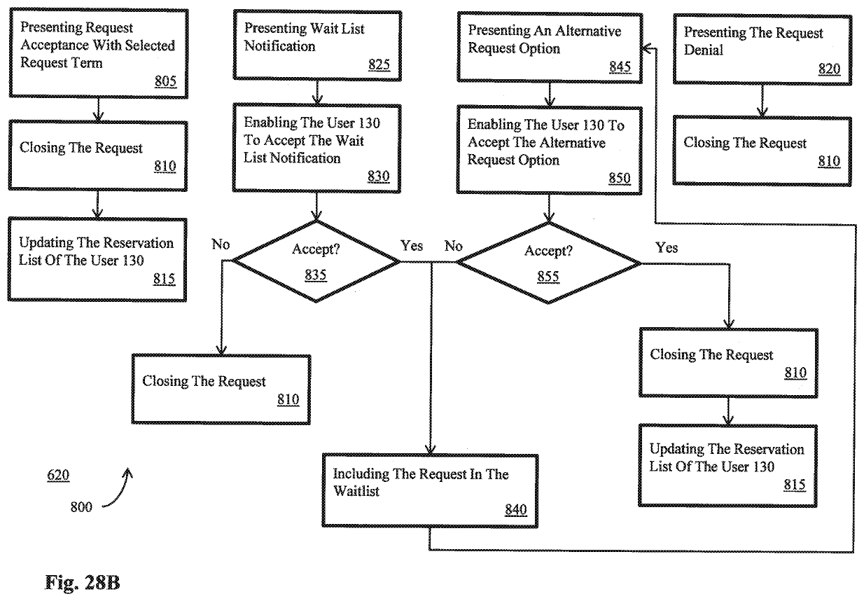

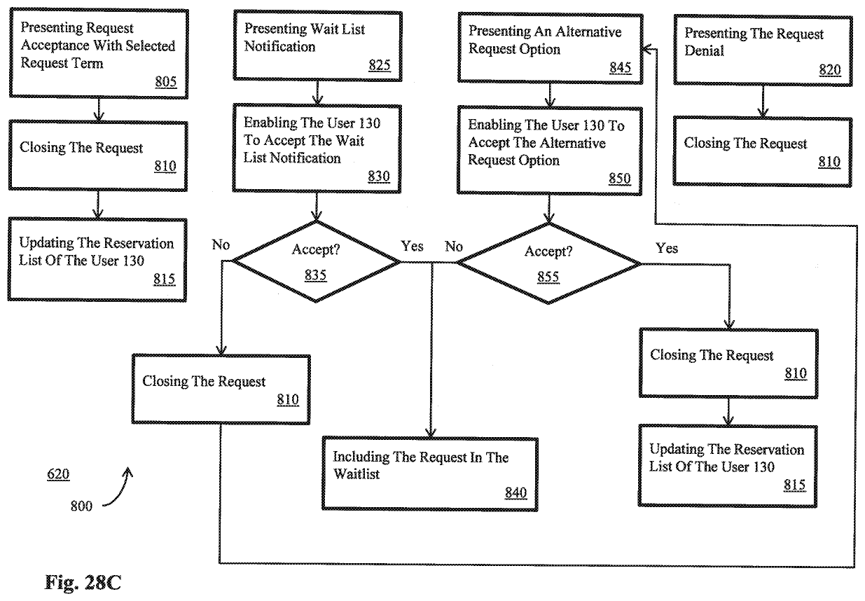

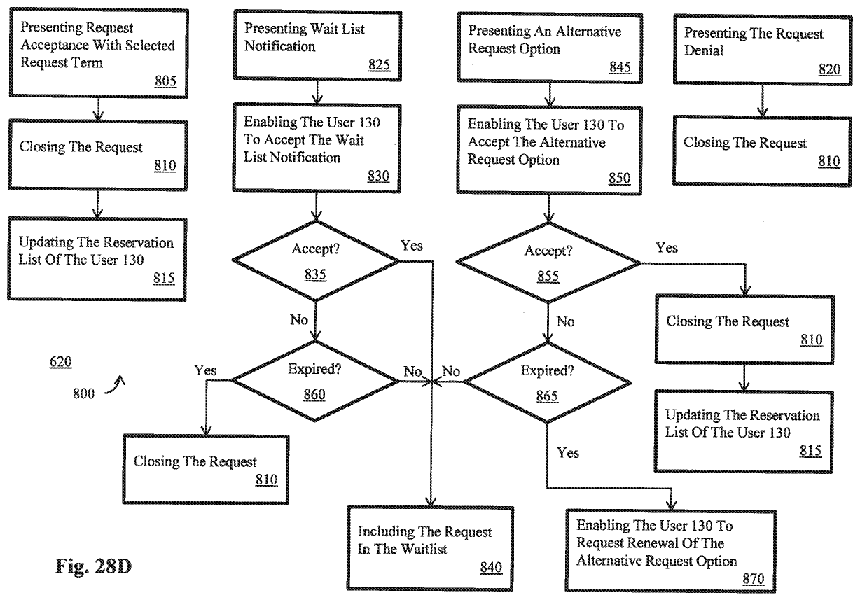

The request acceptance with the new and/or different request term can be provided to the user 130, at 726G. The request acceptance with the new and/or different request term optionally can set forth an expiry term for the request acceptance that the user 130 can take action on. Stated somewhat differently, the new and/or different request term of the request acceptance can include an optional expiry term. The request acceptance thereby can expire if the user 130 does not accept or otherwise confirm the request acceptance in accordance with the expiry term. For example, the request acceptance can expire if the user 130 does not accept the request acceptance within a predetermined period of time after the request acceptance is presented. In the manner discussed in more detail below with reference to FIG. 28D, the user 130 can seek renewal of an expired request acceptance such that the expired request acceptance can be accepted outside of the expiry term.

The request acceptance optionally can include one or more acceptance criteria, such as a predetermined period of time, under which the selected request can remain pending. The selected request, for example, can be deemed cancelled once at least one of the acceptance criteria is no longer satisfied. Based upon a determination that the selected request can be accommodated with the available inventory, the request acceptance with the acceptance criteria can be provided to the user 130, at 726E. The terms of the acceptance criteria preferably are presented to the user 130. Although shown and described as applying to a request acceptance with the specified request term for purposes of illustration only, the optional acceptance criteria can be applied to any type of request acceptance, including request acceptance with one or more new and/or different request terms.

Additionally and/or alternatively, the selected request can be assigned to a wait list of the provider 120 if the selected request cannot be accommodated with the available inventory. The selected request thereby can be held in case additional inventory suitable for the selected response subsequently becomes available. The provider 120 can determine, at 726H, whether the selected request should be held for future available inventory. The wait list determination optionally can include a determination of one or more wait list criteria, such as a predetermined period of time, under which the selected request can remain on the wait list. The terms of the wait list criteria preferably are presented to the user 130, and the selected request can be automatically removed from the wait list once at least one of the wait list criteria is no longer satisfied. Based upon a determination that the selected request should be held for future available inventory, a notification (or offer) that the selected request has been designated for assignment to the wait list can be provided to the user 130, at 726J, optionally with the wait list criteria. Otherwise, the user 130 can be provided with a notification, at 726I, that the selected request was declined by the provider 120.

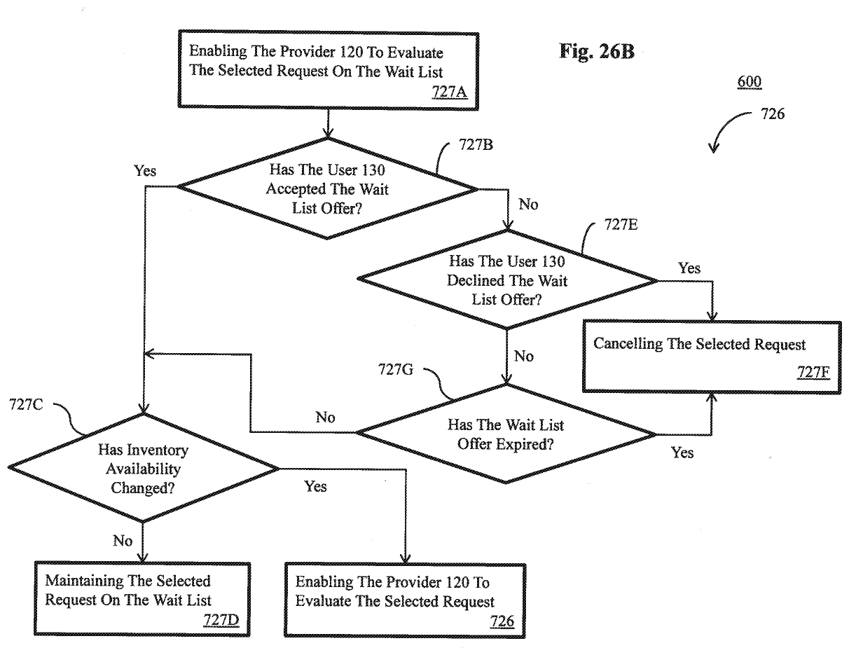

FIGS. 26A-B illustrate exemplary manners by which the provider 120 can evaluate the selected request when the selected request comprises a request that has been assigned to the wait list. Turning to FIG. 26A, for example, the provider 120 can be enabled to evaluate the selected request on the wait list, at 727A. At 727B, a determination can be made whether the user 130 has responded to the notification that the selected request has been designated for assignment to the wait list. If the user 130 has responded to the notification by agreeing to placement of the selected request on the wait list, the provider 120 can determine whether inventory availability has changed, at 727C. If the inventory availability has changed, the provider 120 can be enabled to evaluate the selected request, at 726, in the manner discussed above with reference to FIGS. 25A-B. Otherwise, the selected request can be maintained on the wait list, at 727D.

A determination likewise can be made, at 727E, whether the user 130 has declined to have the selected request placed on the wait list. If the user 130 has not declined to have the selected request placed on the wait list, the provider 120 can determine whether inventory availability has changed, at 727C, in the manner set forth above. The selected request, alternatively, can be cancelled, at 727F, if the user 130 has declined to have the selected request placed on the wait list.

As discussed above, the wait list determination optionally can include a determination of one or more wait list criteria, such as a predetermined period of time, under which the selected request can remain on the wait list. If the wait list includes one or more wait list criteria, a determination can be made, at 727G, whether at least one of the wait list criteria is no longer satisfied as shown in FIG. 26B. If one or more of the wait list criteria is no longer satisfied, the wait list notification can expire, resulting in cancellation of the selected request, at 727F. Otherwise, the provider 120 can determine whether inventory availability has changed, at 727C, in the manner set forth above.

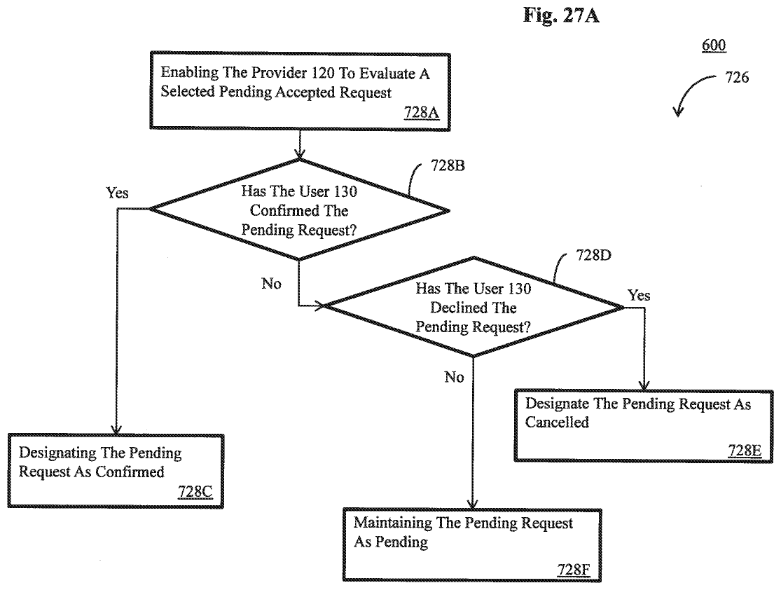

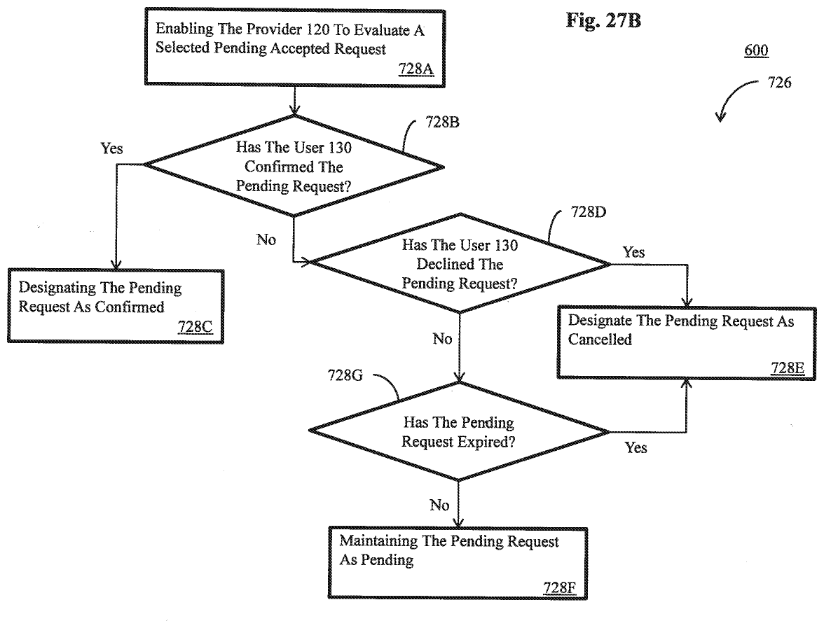

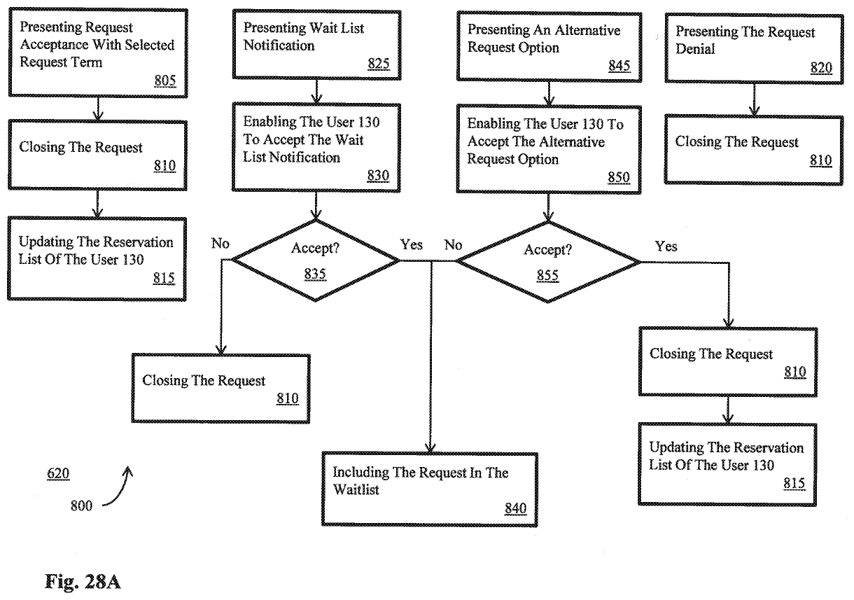

The provider 120 alternatively can evaluate the selected request when the selected request comprises a pending request that has been accepted by the provider 120 and that is pending action by the user 130. Turning to FIG. 27A, for example, the provider 120 can be enabled to evaluate the selected request, at 728A. A determination can be made, at 728B, whether the user 130 has confirmed the selected request. The selected request can be designated as being confirmed, at 728C, if the user 130 has confirmed the selected request. Alternatively and/or additionally, a determination can be made, at 728D, whether the user 130 has declined the selected request. The selected request can be designated as being cancelled, at 728C, if the user 130 has cancelled the selected request. The cancelled request can be removed from the presented list of requests discussed above with reference to FIG. 22. If the user 130 has neither confirmed nor declined the selected request, the selected request can remain pending, at 728F.

As discussed above, the request acceptance optionally can include one or more acceptance criteria, such as a predetermined period of time, under which the selected request can remain pending. If the request acceptance includes one or more acceptance criteria, a determination can be made, at 728G, whether at least one of the acceptance criteria is no longer satisfied as shown in FIG. 27B. If one or more of the acceptance criteria is no longer satisfied, the request acceptance can expire, resulting in cancellation of the selected request, at 728E. Otherwise, the selected request can remain pending, at 728F, if the user 130 has neither confirmed nor declined the selected request.

As set forth above with reference to FIG. 21A, closing the request, at 620, can include enabling the user 130 to proceed with the request based upon the response provided by the provider 120, at 800. Exemplary manners by which the concierge method 600 can close the request are illustrated in FIGS. 28A-D. Turning to FIG. 28A, for example, a request acceptance can be provided to the user 130 in the manner discussed with reference to FIGS. 25A-B. The request acceptance can be presented to the user 130, at 805, and the request can be closed, at 810, preferably without further involvement by the user 130. The reservation list of the user 130 also can be updated to include a schedule for fulfillment of the request in the manner discussed above. Alternatively, the user 130 can be provided with a notification that the selected request was declined by the provider 120 as discussed above with reference to FIGS. 25A-B. The notification can be presented to the user 130, at 820, and the request can be closed, at 810, preferably without further involvement by the user 130.

A notification that the selected request has been designated for assignment to the wait list alternatively can be provided to the user 130 as discussed above with reference to FIGS. 25A-B and 26A-B. At 825, the notification can be presented to the user 130. The user 130 can be enabled to respond to the wait list notification, at 830, and can be provided with the options of accepting or declining the wait list notification, at 835. If the user 130 declines the wait list notification, the request can be closed, at 810, preferably without further involvement by the user 130. Alternatively, the selected request can be included in the wait list of the provider 120, at 840, if the user 130 accepts the wait list notification. Upon closing the selected request, at 810, and/or adding the selected request to the wait list, at 840, one or more alternative request options can be presented to the user 310, at 845, as illustrated in FIGS. 28C and 28B. In the manner discussed above, the request options can include the request acceptance with the new and/or different request term and/or a recommendation of an alternative provider 120 with sufficient available inventory for fulfilling the request.

Alternatively, a request acceptance with the new and/or different request term can be provided to the user 130 as discussed above with reference to FIGS. 25A-B. At 845, the request acceptance can be presented to the user 130. The user 130 can be enabled to respond to the request acceptance, at 850, and can be provided with the options of accepting or declining the request acceptance, at 855. If the user 130 declines the request acceptance, the selected request can be included in the wait list of the provider 120, at 840. Otherwise, the request can be closed, at 810, and the reservation list of the user 130 can be updated, at 815, to include a schedule for fulfillment of the request as discussed above, both preferably without further involvement by the user 130.

In the manner discussed above with reference to FIG. 25B, any type of request acceptance optionally can include one or more acceptance criteria and can be deemed cancelled once at least one of the acceptance criteria is no longer satisfied. FIG. 28D illustrates an exemplary manner by which the user 130 can be enabled to proceed, for example, with a request acceptance with new and/or different request terms that includes acceptance criteria. At 865, a determination can be made whether the acceptance criteria is satisfied. If the acceptance criteria is not satisfied, the request can be included in the wait list of the provider 120, at 840. The user 130 thereby can be provided with additional time to consider whether the new and/or different request terms are acceptable. The request can be closed in the manner set forth above if the acceptance criteria is satisfied. Alternatively, the user 130 can be enabled to apply for the request to be included in the wait list to enable the user 130 to further consider the new and/or different request terms. Although shown and described as applying to a request acceptance with one or more new and/or different request terms for purposes of illustration only, the user 130 can be enabled to proceed with a request acceptance with the specified request term that includes acceptance criteria in a similar manner.

Additionally and/or alternatively, the wait list determination optionally can include one or more wait list criteria by which the selected request can be removed from the wait list once at least one of the wait list criteria is no longer satisfied as set forth above with reference to FIG. 26B. FIG. 28D illustrates an exemplary manner by which the user 130 can be enabled to proceed with a wait list determination that includes wait list criteria. At 860, a determination can be made whether the wait list criteria is satisfied. If the wait list criteria is not satisfied, the request can be included in the wait list of the provider 120, at 840. The user 130 thereby can be provided with additional time to consider how to proceed with the request. The request can be closed, at 810, without further involvement by the user 130 if the wait list criteria is satisfied.

Although the inventory management system 100 described above is disclosed in terms of a demand-side concierge service, additionally and/or alternatively, the inventory management system 100 can also allow the provider 120 to update the concierge system 110 with selected availability for supplying a service and/or product. Advantageously, the inventory management system 100 can provide a demand-side service as described above, a supply-side concierge service, and/or a combination of the above.

For example, the user 130 contacts the concierge system 110 with a request for one or more products and/or services. Upon receiving the request, the concierge system 110 assumes ownership of the request and initiates fulfillment of the request. In contrast to the embodiment discussed with referenced to FIG. 2, the provider 120 may have provided the concierge system 110 with details regarding available inventory. Based on the availability of selected providers 102, the concierge system 110 preferably takes full responsibility for fulfilling the request with minimal, if any, further involvement by the user 130.

The request can include one or more request terms. Exemplary request terms can include conventional contract terms such as a requested product and/or service, a requested provider 120, a requested price, a requested delivery location, and/or a requested delivery time (and/or date). Advantageously, the concierge system 110 can enable the user 130 to identify multiple providers 120 in the request. In one embodiment, the availability of one of the requested providers 120 is compared to other request terms and the concierge system 110 can match a request with a predetermined availability in the manner discussed above.

Even further, in some embodiments, any of the functionality discussed above can be embodied in a software application or component made for one or more different software platforms. For example, a desk accessory, applet, a Web widget, or a graphical user interface (GUI) widget can be used.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

Therefore, the following is claimed:

1. A method, comprising:
receiving a first request for an electronic reservation for a contested resource from a mobile device through a network;
automatically determining a suggested additional percentage over an established value of the contested resource to be provided in fulfillment of the electronic reservation for the contested resource, the suggested additional percentage being determined based at least in part a demand level for the contested resource;
transmitting, through the network, data encoding a first user interface for display on the mobile device, the first user interface being configured to recommend the suggested additional percentage in order to create the electronic reservation and comprising one or more graphical components to modify the suggested additional percentage;
receiving, from the mobile device through the network, a second request to create the electronic reservation at a specified additional percentage over the established value of the contested resource; and
responsive to receiving the second request, creating the electronic reservation for the contested resource.

2. The method of claim 1, further comprising, responsive to receiving the second request:
generating data encoding a second user interface for display on a client device, the second user interface comprising one or more graphical components that facilitate accepting or rejecting the second request; and
transmitting, through the network to a client device, the data encoding the second user interface.

3. The method of claim 2, wherein the second user interface includes a requested delivery date and a requested delivery time.

4. The method of claim 2, further comprising in response to receiving data indicating that the second request was rejected via the second user interface, generating an alert on the mobile device indicating that the second request was rejected and the electronic reservation has not been created.

5. The method of claim 2, further comprising in response to receiving data indicating that the second request was accepted via the second user interface, generating an alert on the mobile device indicating that the second request was accepted and the electronic reservation has been created.

6. The method of claim 1, wherein the demand level is based at least in part on a plurality of requests to create a plurality of different electronic reservations for the contested resource.

7. The method of claim 1, wherein the suggested additional percentage is determined further based at least in part on historical data indicating specified additional percentages associated with accepted electronic reservations in view of the demand level.

8. A computer system, comprising:
a processor;
a memory; and
instructions stored in the memory that, when executed by the processor, cause the computer system to at least:
receive a first request for an electronic reservation for a contested resource from a mobile device through a network;
automatically determine a suggested additional percentage over an established value of the contested resource to be provided in fulfillment of the electronic reservation for the contested resource, the suggested additional percentage being determined based at least in part a demand level for the contested resource;
transmit, through the network, data encoding a first user interface for display on the mobile device, the first user interface being configured to recommend the suggested additional percentage in order to create the electronic reservation and comprising one or more graphical components to modify the suggested additional percentage;
receive, from the mobile device through the network, a second request to create the electronic reservation at a specified additional percentage over the established value of the contested resource; and
responsive to receipt of the second request, create the electronic reservation for the contested resource.

9. The computer system of claim 8, wherein the instructions, when executed by the processor in response to receipt of the second request, further cause the computer system to at least:
generate data encoding a second user interface for display on a client device, the second user interface comprising one or more graphical components that facilitate accepting or rejecting the second request; and
transmit, through the network to a client device, the data encoding the second user interface.

10. The computer system of claim 9, wherein the second user interface includes a requested delivery date and a requested delivery time.

11. The computer system of claim 9, wherein the instructions, when executed by the processor in response to receipt of the of data indicating that the second request was rejected via the second user interface, further cause the computer system to at least generate an alert on the mobile device indicating that the second request was rejected and the electronic reservation has not been created.

12. The computer system of claim 9, wherein the instructions, when executed by the processor in response to receipt of the of data indicating that the second request was rejected via the second user interface, further cause the computer system to at least generate an alert on the mobile device indicating that the second request was accepted and the electronic reservation has been created.

13. The computer system of claim 8, wherein the demand level is based at least in part on a plurality of requests to create a plurality of different electronic reservations for the contested resource.

14. The computer system of claim 8, wherein the suggested additional percentage is determined further based at least in part on historical data indicating specified additional percentages associated with accepted electronic reservations in view of the demand level.

15. A non-transitory computer-readable medium storing instructions that when executed by a processor of a computer system cause the computer system to at least:
receive a first request for an electronic reservation for a contested resource from a mobile device through a network;
automatically determine a suggested additional percentage over an established value of the contested resource to be provided in fulfillment of the electronic reservation for the contested resource, the suggested additional percentage being determined based at least in part a demand level for the contested resource;
transmit, through the network, data encoding a first user interface for display on the mobile device, the first user interface being configured to recommend the suggested additional percentage in order to create the electronic reservation and comprising one or more graphical components to modify the suggested additional percentage;
receive, from the mobile device through the network, a second request to create the electronic reservation at a specified additional percentage over the established value of the contested resource; and
responsive to receipt of the second request, create the electronic reservation for the contested resource.

16. The non-transitory computer-readable medium of claim 15, wherein the instructions, when executed by the processor in response to receipt of the second request, further cause the computer system to at least:
generate data encoding a second user interface for display on a client device, the second user interface comprising one or more graphical components that facilitate accepting or rejecting the second request; and
transmit, through the network to a client device, the data encoding the second user interface.

17. The non-transitory computer-readable medium of claim 16, wherein the second user interface includes a requested delivery date and a requested delivery time.

18. The non-transitory computer-readable medium of claim 16, wherein the instructions, when executed by the processor in response to receipt of the of data indicating that the second request was rejected via the second user interface, further cause the computer system to at least generate an alert on the mobile device indicating that the second request was rejected and the electronic reservation has not been created.

19. The non-transitory computer-readable medium of claim 17, wherein the instructions, when executed by the processor in response to receipt of the of data indicating that the second request was rejected via the second user interface, further cause the computer system to at least generate an alert on the mobile device indicating that the second request was accepted and the electronic reservation has been created.

20. The non-transitory computer-readable medium of claim 15, wherein the suggested additional percentage is determined further based at least in part on historical data indicating specified additional percentages associated with accepted electronic reservations in view of the demand level.
